(19) United States
(12) Patent Application Publication
(10) Pub. No.: US 2016/0300376 A1
(43) Pub. Date: Oct. 13, 2016

(54) IMAGE PROCESSING METHOD AND IMAGE PROCESSING SYSTEM

(71) Applicant: FUJITSU LIMITED, Kawasaki-shi (JP)

(72) Inventors: TAKASHI FUSE, Hadano (JP); Tetsuo Koezuka, Hachiouji (JP)

(73) Assignee: FUJITSU LIMITED, Kawasaki-shi (JP)

(21) Appl. No.: 15/184,424

(22) Filed: Jun. 16, 2016

Related U.S. Application Data
(63) Continuation of application No. PCT/JP2014/050040, filed on Jan. 6, 2014.

(51) Int. Cl. G06T 11/60; G06K 9/46; G06T 7/00

(52) U.S. Cl. CPC G06T 11/60; G06T 7/0081; G06K 9/4661

(57) ABSTRACT

A processor divides each of a plurality of images in which an imaging target is captured under a plurality of different illumination conditions into a plurality of areas, to generate a plurality of divided areas. According to luminance information of a plurality of divided images corresponding to one area among the plurality of areas, the processor selects one divided image among the plurality of divided images corresponding to the one area. Further, the processor combines the one divided image with divided images corresponding to areas other than the one area, to generate an image corresponding to the plurality of areas.

### CROSS-REFERENCE TO RELATED APPLICATIONS

This application is a continuation application of International Application PCT/JP2014/050040 filed on Jan. 6, 2014 and designated the U.S., the entire contents of which are incorporated herein by reference.

### FIELD

The embodiments discussed herein are related to an image processing method, an image processing system, and a program.

### BACKGROUND

In recent years the designs of small devices such as mobile phones have become more refined and have come to possess complex surface shapes. For example, it tends to be that few surfaces of the casings of small devices consist of only flat surfaces. In order to inspect defects on such surfaces of small devices, there is an increasing need for a more strict investigation of defects on target surfaces. Therefore, there is a demand for obtaining images in which the surface shapes are more clearly captured.

As a technique for obtaining more clearly captured images, for example, a technique has been known for displaying frame images arranged in an order that is based on a plurality of read images of a still object being captured while changing at least either the illumination position and the illumination direction of the light source. A technique has also been known in which the shades of the object in an image are corrected in order to compound a plurality of images with different light-source directions. In addition, a technique has been known in which, from a registered image that represents an object, and three-dimensional shape data that associates respective points of the three-dimensional shape of the object with pixels of the registered image, the shades in the registered image are estimated, and a highlighting-removed image from which the specular-reflection component has been removed is generated (for example, see Patent document 1-3).
Patent document 1: Japanese Laid-open Patent Publication No. 2003-132350
Patent document 2: Japanese Laid-open Patent Publication No. 5-233826
Patent document 3: International Publication Pamphlet No. WO2010-026983

### SUMMARY

In an image processing method according to an embodiment, a processor divides each of a plurality of images in which an imaging target is captured under a plurality of different illumination conditions into a plurality of areas, to generate a plurality of divided areas. According to luminance information of a plurality of divided images corresponding to one area among the plurality of areas, the processor selects one divided image among the plurality of divided images corresponding to the one area. Further, the processor combines the one divided image with divided images corresponding to areas other than the one area, to generate an image corresponding to the plurality of areas.

An image processing system that is another embodiment includes an illumination apparatus, an imaging apparatus, a storage apparatus, an illumination control unit, an imaging control unit, an image dividing unit, a selecting unit, and a combining unit. The illumination apparatus performs illumination for an imaging target under a plurality of illumination conditions. The imaging apparatus captures an image of the imaging target. The storage apparatus stores information. The illumination control unit controls an operation of the illumination apparatus. The imaging control unit makes the imaging apparatus capture an image of the imaging target captured a plurality of times under the different illumination conditions imaging, and stores a plurality of captured images in the storage apparatus. The image dividing unit divides each of the plurality of images stored in the storing unit into a plurality of areas, to generate a plurality of divided images, and also stores the divided images in the storage apparatus. The selecting unit selects, according to luminance information of the plurality of divided images corresponding to one area among the plurality of areas, one divided image among the plurality of divided images corresponding to the one area. The combining unit combines the one divided image with divided images of areas other than the one area, to generate an image corresponding to the plurality of areas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram presenting an example of the functional configuration of an image processing apparatus according to the first embodiment;

FIG. 2 is a figure presenting an example of the capturing method for an image that is accepted by an image accepting unit according to the first embodiment;

FIG. 3 is a figure presenting an example of a plurality of images according to the first embodiment;

FIG. 4 is a figure presenting an example of image division according to the first embodiment;

FIG. 5 is a figure presenting an example of a plurality of divided images corresponding to an area according to the first embodiment;

FIG. 6 is a figure presenting an example of luminance distribution of each divided image according to the first embodiment;

FIG. 7 is a figure presenting an example of an evaluation value table according to the first embodiment;

FIG. 8 is a figure presenting an example of a selected image table according to the first embodiment;

FIG. 9 is a figure presenting an example of an recombined image according to the first embodiment;

FIG. 10 is a flowchart presenting an example of operations of an image processing apparatus according to the first embodiment;

FIG. 11 is a figure presenting an example of the hardware configuration of an image processing system according to the second embodiment;

FIG. 12 is a figure presenting an example of the functional configuration of a control apparatus according to the second embodiment;

FIG. 13 is a figure presenting an example of an imaging situation by an image processing system according to the second embodiment;

FIG. 14 is a figure presenting an example of an occurrence of directly reflected light according to the second embodiment;

FIG. 15 is a figure presenting an example of the change in imaging light intensity according to the second embodiment;

FIG. 16 is a figure presenting an example of an evaluation value table according to the second embodiment;

FIG. 17 is a figure presenting a luminance distribution assuming that the frequency of luminance gradation values represents a normal distribution according to the second embodiment;

FIG. 18 is a figure presenting an example of images including protrusions according to the second embodiment;

FIG. 19 is a figure presenting a luminance distribution in pixels corresponding to the protrusion according to the second embodiment;

FIG. 20 is a figure presenting an example of boundary processing in recombining images according to the second embodiment;

FIG. 21 is a figure presenting an example of a recombined image before and after boundary processing is performed according to the second embodiment;

FIG. 22 is a flowchart presenting major operations of an image processing system according to the second embodiment;

FIG. 23 is a flowchart presenting details of a directly reflected light image removal process according to the second embodiment;

FIG. 24 is flowchart presenting an image selection process according to the second embodiment;

FIG. 25 is a flowchart presenting details of boundary processing according to the second embodiment; and

FIG. 26 is a figure presenting an example of the hardware configuration of a standard computer.

### DESCRIPTION OF EMBODIMENTS

However, for example, in automatic inspection of surfaces of mobile devices and the like, the possibility that highlighting that negatively affects the inspection will be generated increases, depending on the surface shape of the target of inspection. Highlighting refers to strong light such as directly reflected light that is reflected directly onto the imaging apparatus by the imaging and that comes close to the upper limit of the luminance gradation values of the captured image. For example, when an image of an inner portion of a part of the surface of a target covered by a transparent member is captured across the transparent member or an image of a portion of a smooth surface shape is captured while applying illumination, a problem arises in which, due to the influence of the highlighting or the like, image information of the portion that is the target of inspection is hidden and may not be obtained. In a situation in which, in particular, the need for automatic inspection is increasing from the viewpoints of reducing inspection costs and quantitatively determining the test result, there is a demand for an imaging method with which the influence of highlighting or the like that negatively affects the inspection is further reduced and a more minute image of the imaging target may be obtained.

Therefore, an objective of the present invention is to generate an image that accurately includes surface information of the imaging target.

### First Embodiment

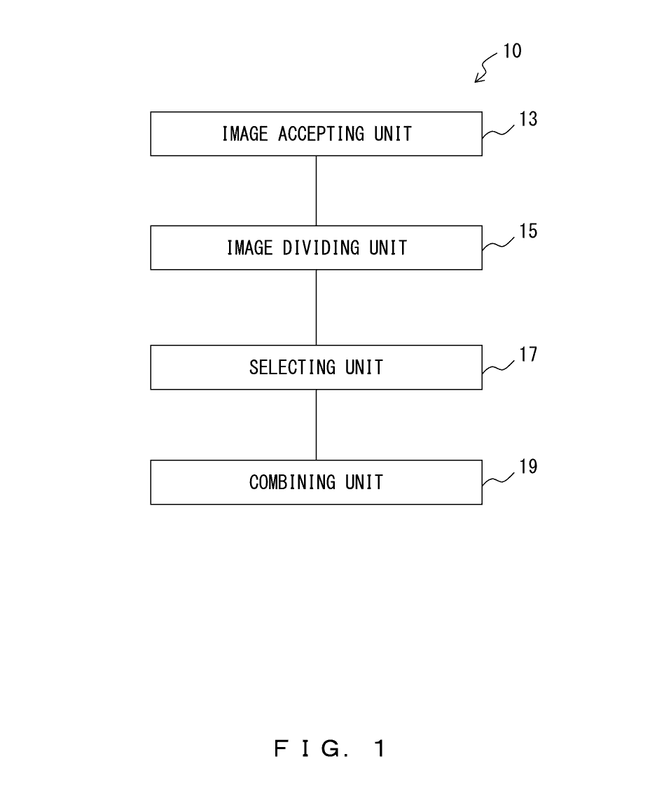

Hereinafter, the first embodiment is explained according to the figures. FIG. 1 is a block diagram presenting an example of the functional configuration of an image processing apparatus 10 according to the first embodiment. The image processing apparatus 10 accepts a plurality of images in which the same imaging target is captured under different illumination conditions, divides each into a plurality of areas, and selects a divided image that corresponds to one area, according to luminance information of divided images corresponding to the one area. In addition, the image processing apparatus 10 is also an apparatus that combines the selected divided image that corresponds to the one area with divided images that correspond to the areas other than the one area, to generate an image that corresponds to a plurality of areas. The image processing apparatus 10 is realized by reading and executing a program that causes a standard computer to execute processing as the image processing apparatus 10, for example.

Each of the plurality of areas is an area that is identical between the plurality of images. In one image, division of the respective areas may be made in any way. For example, division into a plurality of areas may be made with a plurality of straight lines drawn vertically and horizontally, or division may be made into an area that is a particular portion enclosed by a curved line, and an area that is its exterior portion. In one image, the dimensions of the respective areas do not need to be the same.

Illumination conditions are the intensity of the light that is cast on the imaging target or the illuminance of the imaging target, and the strength of light that is reflected on the imaging target and enters the imaging device, for example. Illumination conditions also include conditions that change the intensity of light that enters the imaging device, such as the stop, the exposure time of the imaging device, and conditions that change the luminance of the respective pixels when they are converted into an image, such as the sensitivity of the imaging device or the like. Here, the intensity or the illuminance of the light is not supposed to be an absolute value, and is supposed to be a relative value that corresponds to the photon flux density that is cast or reflected on the imaging target, such as the electric power applied to the illumination, or the like. In addition, an illumination condition is a three-dimensional angle (hereinafter, referred to as an illumination direction) between the surface of the imaging target or the plane on which the imaging target is placed and a straight line that connects the light source of the illumination light and the center of the imaging target, or the like. Details of illumination conditions are further described later.

As presented in FIG. 1, the image processing apparatus 10 includes an image accepting unit 13, an image dividing unit 15, a selecting unit 17, and a combining unit 19. The image accepting unit 13 accepts a plurality of images captured under different illumination conditions with the same field of view including the same imaging target. The image processing apparatus 10 may read and accept images from a storage apparatus that is connected by a wire or wirelessly to the image processing apparatus 10. In addition, the image processing apparatus 10 may also be configured so as to receive and accept images captured by an imaging apparatus described later through a wired or wireless communication network.

The image dividing unit 15 divides the plurality of images accepted by the image accepting unit 13 into a plurality of areas that are identical between the plurality of the images. Hereinafter, each of the images divided into a plurality of areas is referred to as a divided image. In addition, the images before division are referred to as the original images. In the present embodiment, the original images are captured in the state in which the positions of the imaging apparatus and the imaging target are relatively fixed. In addition, the divided images corresponding to the same area are to be divided images of the same field of view with each other.

The selecting unit 17 selects a divided image that is determined to include surface information of the imaging target most accurately, for each area, according to luminance information of the plurality of divided images for each area. Details of the method of selection are described later.

The combining unit 19 regenerates an image corresponding to the original image by recombining the images selected by the selecting unit 17 for the respective areas. As mentioned above, the divided images corresponding to each area correspond to the same field of view, and therefore, an image corresponding to the same field of view as that of the original image is generated by geometrically combining the divided images. Hereinafter, an image generated by combining the divided image selected for each area is referred to as a recombined image.

The respective functions of the image processing apparatus 10 described above are realized by an information processing apparatus such as a standard computer or the like reading and executing a program stored in advance in a storage apparatus.

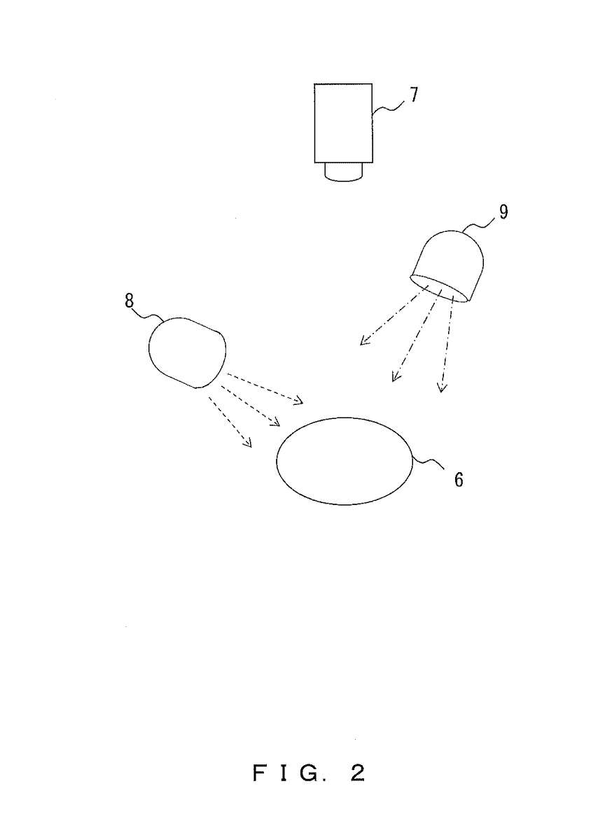

Next, details of the illumination conditions in the present embodiment are explained with reference to FIG. 2. FIG. 2 is a figure presenting an example of the imaging method for an image accepted by the image accepting unit 13. In the example presented in FIG. 2, a camera 7 is fixed with respect to an imaging target 6. In addition, it is assumed that an illumination 8 and an illumination 9 are placed so that their illumination directions with respect to the imaging target 6 are different.

According to the configuration as presented in FIG. 2, for example, an image is captured by the camera 7 in a first illumination condition with only the illumination 8 turned on, and an image is captured in a second illumination condition with only the illumination 9 turned on. Accordingly, two images may be obtained under different illumination conditions that are the illumination directions with respect to the imaging target.

As another example, for example, it is assumed that the intensity of at least one of the illumination 8 and the illumination 9 may be changed. Then, it is assumed that the illuminance in the imaging target 6 may be changed by changing the intensity of one of the illumination lights. In such a case, for example, an image of the imaging target 6 is captured by the camera 7 in the state in which the illumination 8 is turned on with a first intensity, as a first illumination condition. Next, an image of the imaging target 6 is captured by the camera 7 in the state in which the illumination 8 is turned on with a second intensity that is different from the first intensity, as a second illumination condition. Accordingly, two images are obtained under different illumination conditions that are the illuminances of the illumination light with respect to the imaging target.

As another example, for example, the first image may be an image captured in the state in which the illumination 8 is turned on with a first intensity, and the second image may be an image captured in the state in which the illumination 8 is turned on with a second intensity that is different from the first intensity. The second image may be the illumination 9 is also turned on. As described above, it is possible to use conditions in which both the number of illuminations turned on and the intensity of illuminations from a plurality of different angles are changed. Meanwhile, the number of illuminations is not limited to two, and a configuration may be made so as to make the position of one illumination changeable, or three or more illuminations may be placed so that their illumination directions are different from each other, or their illumination directions are changeable.

Of course, as described above, three or more images may be obtained under three or more conditions in which the illumination direction and the illuminance, or at least one of them, is different from that of the others. Meanwhile, for example, changes in the exposure conditions such as the imaging sensitivity, stop, and exposure time are also included as the illumination conditions in the present embodiment, as they have a similar effect as that of changes in the illuminance of the imaging target.

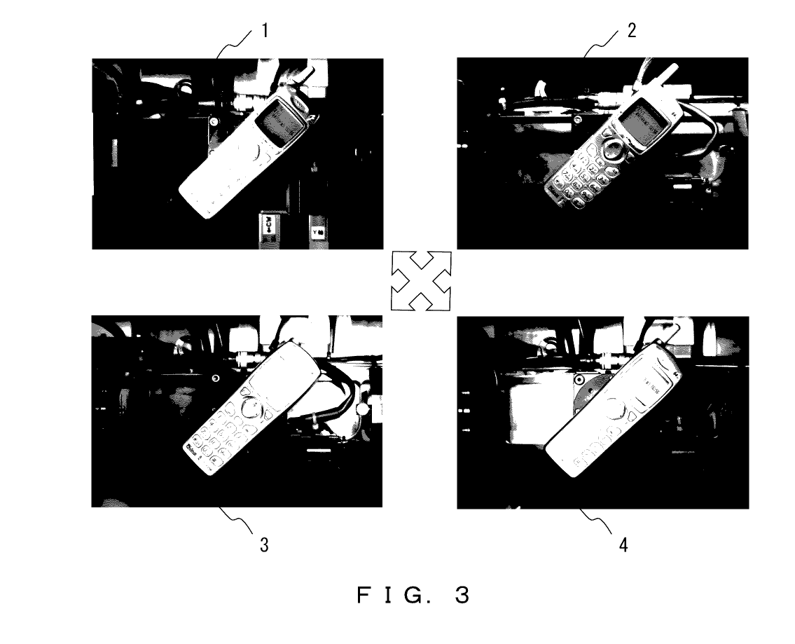

FIG. 3 is a figure presenting an example of a plurality of images 1-4 captured by an imaging device that is fixed with respect to the imaging target, each in a different illumination condition, for example. As presented in FIG. 3, these images 1-4 are examples in which it is visible even to the naked eye that portions with high luminance and portions with low luminance are different depending on the image. Meanwhile, in the present embodiment, it is assumed that, when a color image is input, it is subjected to grey scale conversion, and the luminance gradation values after the conversion are used as luminance information.

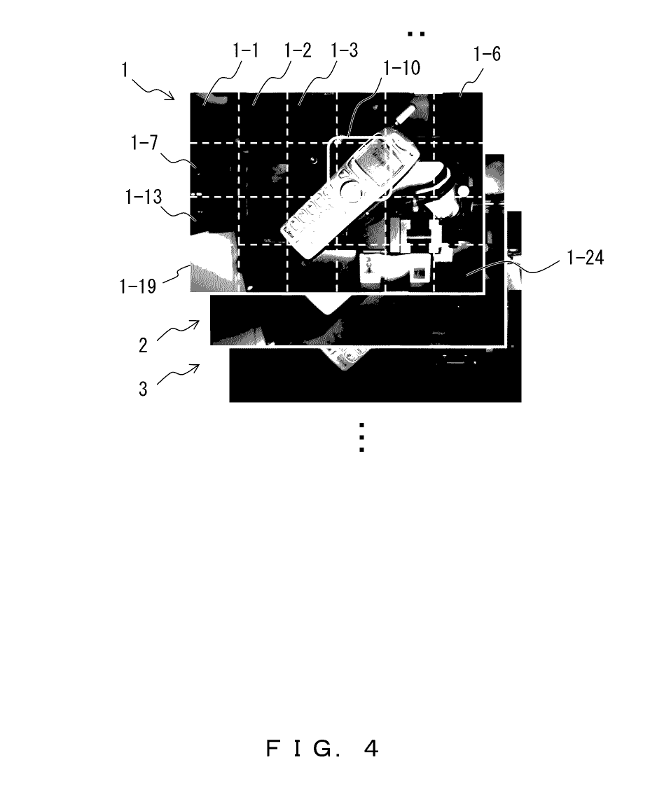

FIG. 4 is a figure presenting an example of image division. FIG. 4 presents an example in which the image 1 is divided into divided images 1-1 through 1-24 of 24 areas, 4 vertically (the row direction)×6 horizontally (the column direction). At this time, while it is not presented in the drawing, the images 2 through 4 are divided into a similar 24 areas. Accordingly, four divided images are obtained for each area.

Meanwhile, an arbitrary original image is referred to as an image n (n is a positive integer) and an arbitrary area is referred to as an m-th area (m is a positive integer). In addition, the divided image of the m-th area of the image n is referred to as a divided image n-m. Hereinafter, explanation is given with an example of a divided image 1-10 presented in FIG. 4. The divided image 1-10 is the divided image of the tenth area.

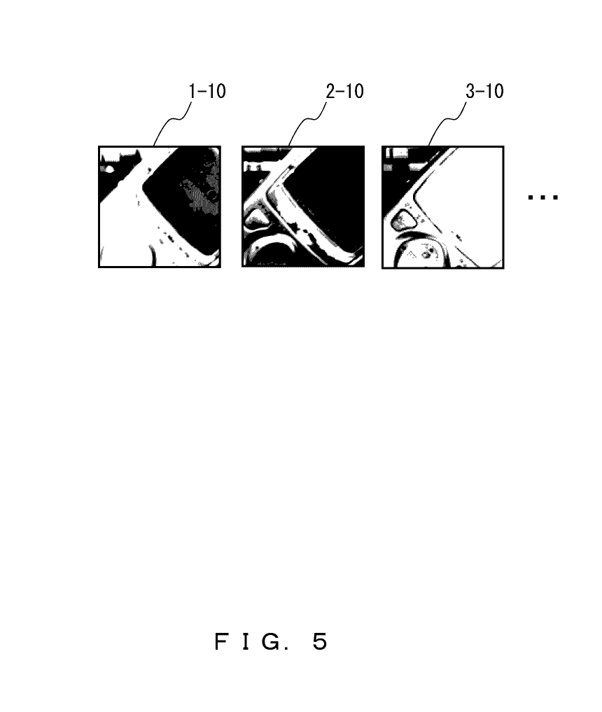

FIG. 5 is a figure presenting an example of a plurality of divided images corresponding to one area. As presented in FIG. 5, the divided image 1-10, a divided image 2-10, a divided image 3-10 and the like corresponding to the tenth area are obtained by dividing each image. It is observed that, although the respective divided images are the images of the same field of view, their luminance distributions are different.

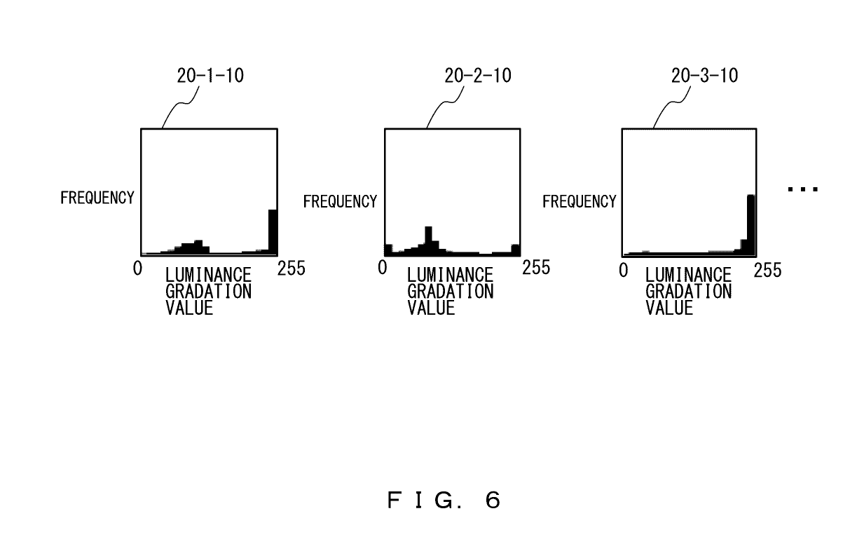

FIG. 6 is a figure presenting an example of luminance distribution for each divided image. In FIG. 6, three graphs 20-1-10 through 20-3-10 correspond to the divided images 1-10, 2-10, 3-10, respectively. In each graph, the horizontal axis represents the luminance gradation value corresponding to the luminance of the divided image, and the vertical axis represents, as a frequency, the number of pixels that has each luminance gradation value in each divided image. It is understood that, as presented in FIG. 6, the distribution of the luminance values (here, the corresponding luminance gradation values) is different for each divided image. By comparing these distributions of luminance values with each other, the divided image that is to be selected for each area is determined. Meanwhile, it is preferable that the distribution of the luminance values represent a normal distribution whose center is the median (here, the luminance gradation value=128) of the luminance values.

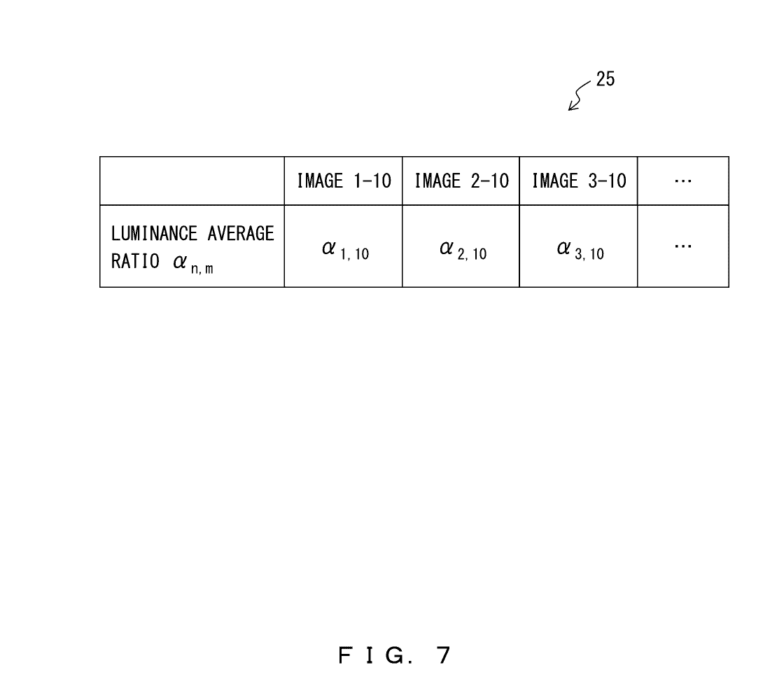

FIG. 7 is a figure presenting an example of an evaluation value table 25. The evaluation value table 25 is information that represents the statistical amount of a feature amount of divided images, and the calculation result of the evaluation value. The feature amount is a value that represents a feature related to luminance information of the divided image. Here, the feature amount is the luminance gradation value as a value corresponding to the luminance value of each pixel. The evaluation value is calculated according to the statistical amount of the feature amount, and it is a value that becomes the selection criterion for selecting one from a plurality of divided images for each area. In the example in FIG. 7, the luminance average ratio α_{n,m} for the divided image n-m is described as the statistical amount that becomes the base for the calculation of the evaluation value.

The luminance average ratio α_{n,m} is the luminance average ratio corresponding to the divided image n-m, and it is calculated by formula 1 below. Meanwhile, the luminance average ratio α_{n,m} is the absolute value of the difference between the average of the luminance gradation values of the respective pixels of the divided image n-m and the median of luminance gradation values.

Here, it is assumed that the divided image n-m consists of j×k pixels (j, k are natural numbers). It is assumed that the luminance gradation value of a pixel (x, y) (x is an integer 0 to j−1 for example, and y is an integer 0 to k−1) of the divided image n-m is expressed as f (x, y). An average value avr_{n,m} represents the average of the luminance gradation values of all the pixels in one divided image n-m. In addition, in this example, there are gradations 0 through 255 as the gradations, and as mentioned above, the gradation 128 that is the median is preferable as the average value of the luminance gradation values of the image. Meanwhile, in the evaluation value table 25, the statistical amount is only the luminance average ratio α_{n,m}, and therefore, the statistical amount is the evaluation value, and it is omitted from the description. In the example in FIG. 7, for example, the divided image n-m that has the largest value of the luminance average ratio α_{n,m} is selected as the divided image for the corresponding area.

$${avr}_{n , m} = \frac{{\sum }_{x = 0}^{j - 1} {\sum }_{y = 0}^{k - 1} f ( x , y )}{jk} \\ {α}_{n , m} = \vert {avr}_{n , m} - 128 \vert \qquad ( formula 1 )$$

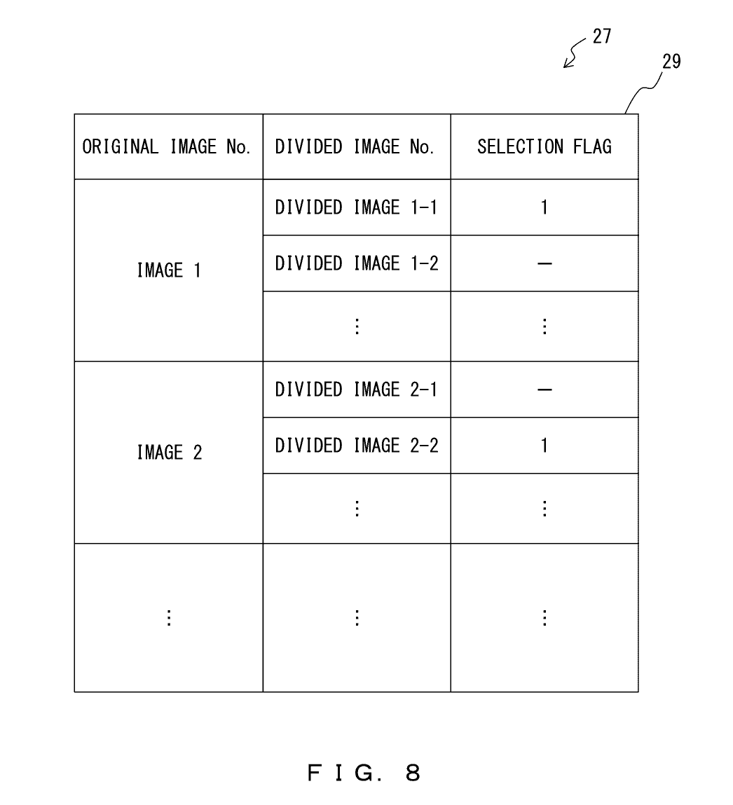

FIG. 8 is a figure presenting an example of a selected image table 27. The image processing apparatus 10 keeps a record of divided images selected as described above. The selected image table 27 may store the original image, the identification numbers of the respective divided images, and a selection flag that indicates whether, from among the images of the same area, selection was made or not, and so on. Meanwhile, the selected image table 27 may also be configured so as to associate, with each image, and to store, information that indicates the storage area in which the image data for each image is stored.

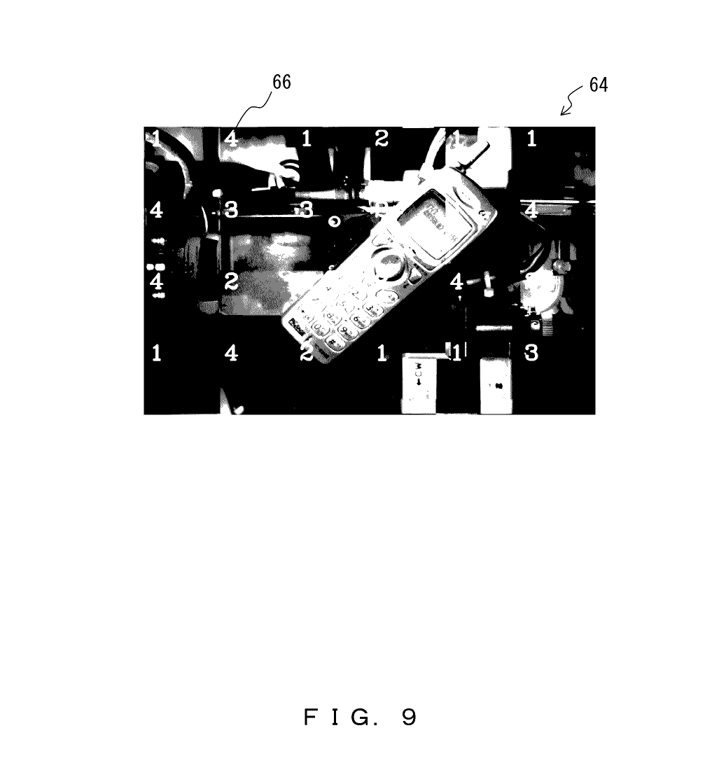

FIG. 9 is a figure presenting an example of a recombined image. A recombined image 64 is an image generated by recombining images selected from a plurality of divided images n-m with each other. The number at the upper left of each divided image, such as an image number 66, indicates the number of the original image selected in each area. For example, it is indicated with image number 66 that the image 4 was selected as the original image. Compared with the images 1-4 in FIG. 3 for example, the recombined image 64 is an image in which highlighting is generally suppressed, the image of the imaging target is captured clearly, and surface information of the imaging target is sufficiently included.

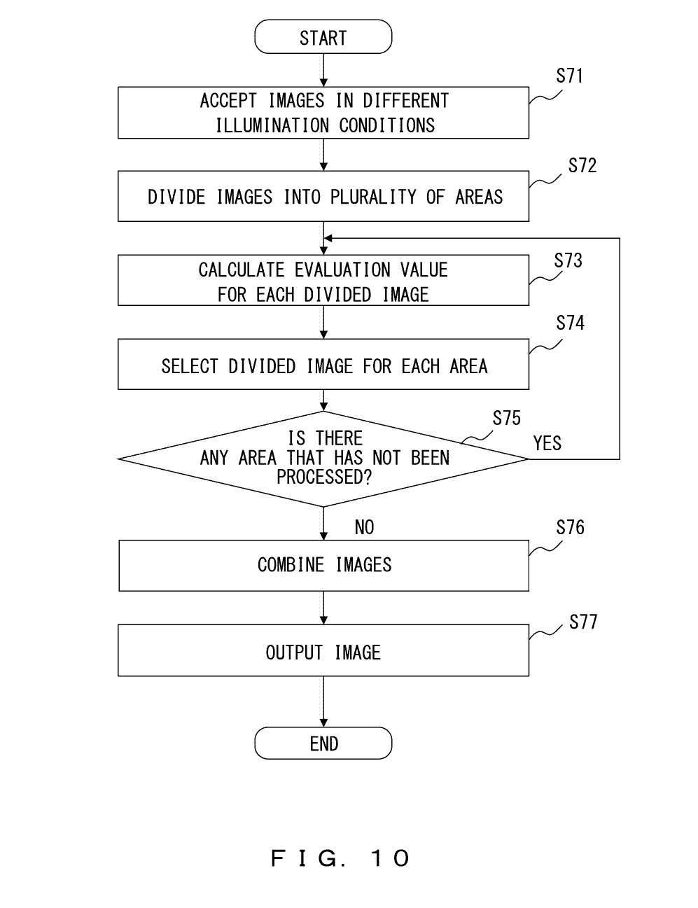

Hereinafter, operations of the image processing apparatus 10 according to the first embodiment are explained with reference to the flowchart. FIG. 10 is a flowchart presenting an example of operations of the image processing apparatus 10. In the explanation below, explanation is given assuming that the respective functions presented in FIG. 1 execute processing.

The image accepting unit 13 accepts a plurality of images with different illumination conditions (S71). For example, the image accepting unit 13 accepts images through a communication network. The image dividing unit 15 divides each of the accepted plurality of images similarly into a plurality of areas (S72). As mentioned above, the image dividing unit 15 divides a plurality of images into divided images of a plurality of areas that are identical between the plurality of the images. The selecting unit 17 calculates the evaluation value for each divided image n-m for each area (S73). That is, the selecting unit 17 first selects one area, and calculates the evaluation value for the selected area. The evaluation value is calculated as in the evaluation value table 25 in FIG. 7, for example.

The selecting unit 17 selects one of the divided images n-m for the selected area, according to the calculated evaluation value (S74). At this time, for example, in the selected image table 27, a selection flag 62 may be raised for the selected divided image n-m.

The selecting unit 17 further judges whether or not there is any area that has not been processed (S75), and when there is (S75: YES), returns to S73 and repeats the process. When there are no areas that have not been processed (S75: NO), the combining unit 19 recombines the respective selected divided images to generate (S76) and output (S77) a recombined image.

As described in detail above, according to the image processing apparatus 10 according to the first embodiment, a plurality of original images of the same field of view captured under different illumination conditions are divided into divided images of a plurality of areas, and the divided images of the same area are compared with each other. At this time, an evaluation value is calculated according to luminance information of each divided image, and one divided image is selected for each area according to the evaluation value, and recombining is performed.

The evaluation value is calculated according to luminance information of each divided image. For example, selecting unit 17 calculates a statistical amount of a feature amount according to luminance information of each divided image so that, for example, the evaluation value becomes high when the distribution of the luminance information becomes close to a favorable distribution such as a normal distribution whose center the median.

According to the image processing as described above, divided images in which the influence of elements such as highlighting that make the image unclear is small may be selected and recombined, so that an image that includes surface information of the imaging target in a sufficiently identifiable manner may be obtained. Accordingly, for example, by using the recombined image according to the present embodiment for inspection of a surface under a transparent member of an object, it is also possible to improve an efficiency and accuracy of the inspection for defects on the painted surface of the casing of a mobile phone or the like whose surface is coated with a transparent member, for example.

Meanwhile, in the first embodiment, a divided image corresponding to one area is selected for each of all the areas, but the divided image does not have to be selected for all of the areas. While the evaluation value is described as the luminance average ratio α_{n,m} calculated according to the luminance gradation values of all the pixels of the divided image, this is not a limitation. The evaluation value may be a value calculated according to a portion of the pixels on the divided image, for example. For example, evaluation may also be made according to a statistical amount calculated according to the feature amount of only the pixels that correspond to an image that has a particular feature.

The luminance average ratio α_{n,m} is a statistical amount related to the average of luminance gradation values as the evaluation value, but for example, the evaluation value may also be a statistical amount related to dispersion, a statistical amount related to the luminance gradation value itself, and further, another statistical amount such as a value obtained by applying a prescribed operation to these statistical amounts. In addition, as the evaluation value, not only the luminance average ratio α_{n,m} for which the luminance gradation value is the feature amount, but also another statistical amount calculated for another feature amount based on luminance information may be used. Other possible feature amounts are, for example, brightness, saturation, edge intensity, or the like. Edge intensity includes a value based on the change ratio of the luminance gradation value, a value based on luminance dispersion described later, and the like.

In the processing described above, when a color image is input, grey scale conversion is performed and the luminance gradation value is used as the luminance information, but this is not a limitation. For example, processing is also possible in which, for example, processing such as that described above is performed according to luminance information for each color of the three primary colors and an evaluation value is output, and a divided image having a high evaluation value is selected from all the divided images of the three primary colors and recombining is performed. Data structures of the evaluation value table 25, the selected image table 27, and the like are examples and may be modified.

### Second Embodiment

Hereinafter, an image processing system 100 according to the second embodiment is explained. In the second embodiment, the same numbers are assigned to the same configurations and the same operations as those of the image processing apparatus 10 according to the first embodiment, and redundant explanations are omitted.

The image processing system 100 is an image processing system that includes, in a control apparatus 110, an image processing apparatus 101 that is a modification example of the image processing apparatus 10 according to the first embodiment. The image processing system 100 captures images of an imaging target, and generates a recombined image based on the captured images. In addition, the image processing system 100 is also able to perform processing as a surface inspection apparatus that performs surface inspection of an inspection target included in the imaging target, using the recombined image.

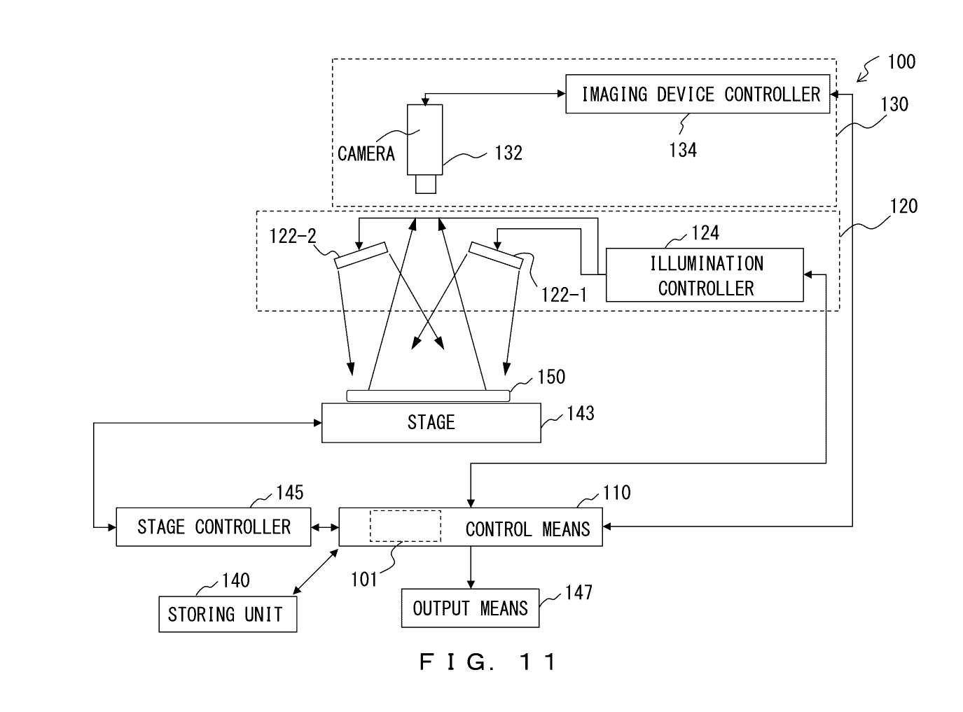

FIG. 11 is a diagram presenting an example of the hardware configuration of the image processing system 100. As presented in FIG. 11, the image processing system 100 includes the control apparatus 110, an illumination apparatus 120, an imaging apparatus 130, a storage apparatus 140, a stage 143, a stage controller 145, and an output apparatus 147.

The control apparatus 110 is an apparatus that controls operations of the image processing system 100, and it may be an information processing apparatus such as a personal computer, for example. The control apparatus 110 includes the same functions as the image processing apparatus 101. Details of the functional configuration of the control apparatus 110 are described later.

The illumination apparatus 120 includes illuminations 122-1, 122-2 (also collectively referred to as the illuminations 122) and an illumination controller 124, and casts light on the imaging target including the inspection target 150 in at least a plurality of illumination conditions, for example. The illuminations 122 are fluorescent lights, Light Emitting Diode (LED) illuminations, or the like. In addition, it is preferable that the illumination direction (the placement position and the illumination-casting direction of the illuminations 112), intensity, and ON/OFF be controlled by means of the illumination controller 124 being controlled by the control apparatus 110. Meanwhile, the illuminations are not limited to two units, and may be one unit, or three units or more. In addition, modifications are possible, such as a configuration in which the illuminations are fixed and the intensity of a plurality of units is not variable. The illumination controller 124 is an apparatus that controls operations of the illuminations 122, and may include a moving mechanism for moving the illuminations 122, an electrical circuit for changing the intensity of the cast light, and so on.

The imaging apparatus 130 includes a camera 132 and an imaging controller 134. The camera 132 is an imaging apparatus equipped with a solid-state imaging device. The camera 132 captures an image of the imaging target including the inspection target 150 by being controlled by the control apparatus 110 via the imaging controller 134. The imaging controller 134 is an apparatus that controls operations of the camera 132, and may include a moving mechanism or the like that performs moving of optical parts such as a lens of the camera 132 and adjustment operations for the stop, shutter and the like.

The storage apparatus 140 is an external storage apparatus, for example. The external storage apparatus is a storage apparatus such as a hard disk, for example. In addition, a medium driving apparatus may be provided, and recording into a portable recording medium may be performed. The portable recording medium is a Compact Disc (CD)-ROM, Digital Versatile Disc (DVD), Universal Serial Bus (USB) memory or the like, for example. In the storage apparatus 140, various control programs executed in the control apparatus 110, obtained data, and the like are stored. In addition, obtained image data and information such as the calculation result of the evaluation value may also be stored.

The stage 143 is a platform on which the inspection target 150 is placed, and it moves by being controlled by the control apparatus 110 via the stage controller 145 and is able to perform position adjustment of the inspection target 150. The stage controller 145 is an apparatus that controls operations of the stage 143 and may include a moving mechanism for the stage 143. The output apparatus 147 is an apparatus that displays the processing result of the image processing apparatus 101 or the like, and it is a liquid-crystal display apparatus or the like, for example.

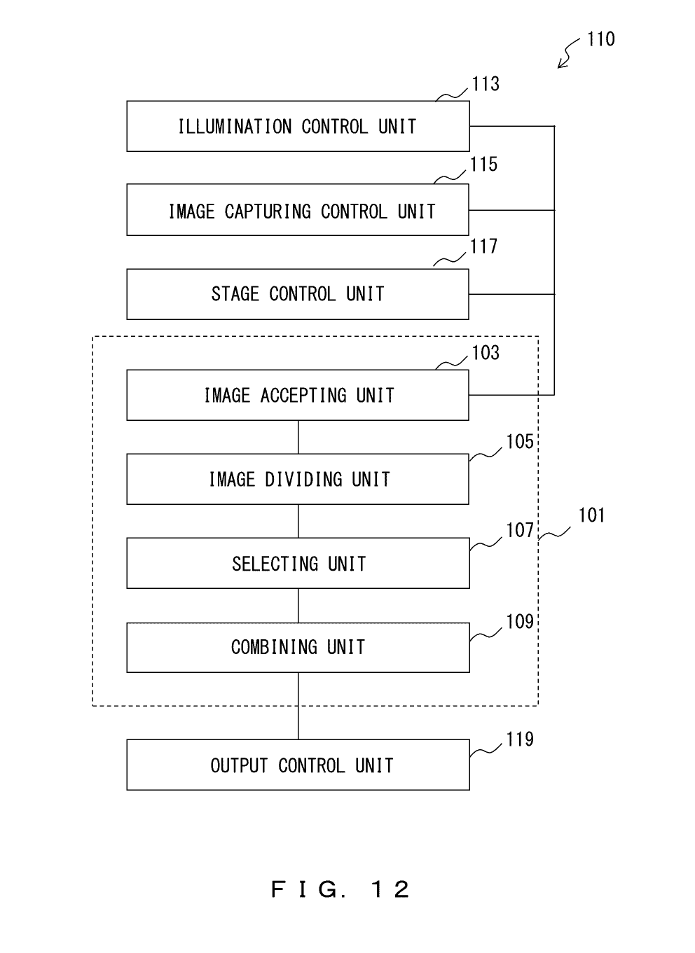

FIG. 12 is a diagram presenting an example of the functional configuration of the control apparatus 110. As presented in FIG. 12, the image processing system 100 includes the image processing apparatus 101, an illumination control unit 113, an imaging control unit 115, a stage control unit 117, and an output control unit 119.

The illumination control unit 113 controls ON/OFF, the illumination direction, intensity and the like of the illumination apparatus 120. When there are a plurality of illuminations 122, it may also be configured to perform. ON/OFF at a different timing for each, or to control the illumination direction and intensity independently for each.

The imaging control unit 115 controls operations of the imaging apparatus 130. The imaging control unit 115 controls the imaging apparatus 130 while cooperating with the illumination control unit 113 so that, for example, imaging is performed in the state in which the illumination control unit 113 is executing an illumination that satisfies a prescribed condition.

The stage control unit 117 controls operations of the stage 143. The stage control unit 117 adjusts the position of the inspection target 150 by controlling the movement of the stage 143 so as to make it possible to perform imaging under a desired illumination condition.

The output control unit 119 controls the output of the output apparatus 147. The output control unit 119 makes the output apparatus 147 display the image of the processing result of the image processing apparatus 101. In addition, when the image processing system 100 is configured to function as a surface inspection apparatus for the inspection target 150, the output control unit 119 may be configured to perform processes related to the inspection. For example, the output control unit 119 performs processing such as determining the degree of matching by comparison with an image that is a reference as to whether or not the surface of the inspection target 150 is manufactured according to the design or the like, and outputs the result.

The image processing apparatus 101 includes an image accepting unit 103, an image dividing unit 105, a selecting unit 107, and a combining unit 109. The image accepting unit 103 accepts a plurality of images in which the same imaging target is captured from the same position with respect to the imaging target under different illumination conditions, for example. The image accepting unit 103 accepts images captured by the camera 132, via the imaging controller 134, for example. The image accepting unit 103 may also read and accept images from a storage apparatus that is connected by a wire or wirelessly to the image processing apparatus 101. The image dividing unit 105 divides a plurality of images accepted by the image accepting unit 103 into a plurality of areas that are identical between the plurality of images. The processing of the image dividing unit 105 is similar to that of the image dividing unit 15.

The selecting unit 107 selects, for each area, a divided image that is determined to include the surface information of the imaging target most accurately, according to illuminance information of the plurality of divided images for each area. In the process of selection according to the second embodiment, processing similar to the processing by the selecting unit 17 explained in the first embodiment is performed. In addition, the selecting unit 17 performs a process for removing the image determined to include directly reflected light from the respective divided images, as described later. Details of this determining process are described later.

The combining unit 109 regenerates an image corresponding to the original image by recombining the images selected by the selecting unit 107 for the respective areas. At this time, it is preferable that the combining unit 109 perform boundary processing at the area boundary portion described later. Details of the boundary processing are described later.

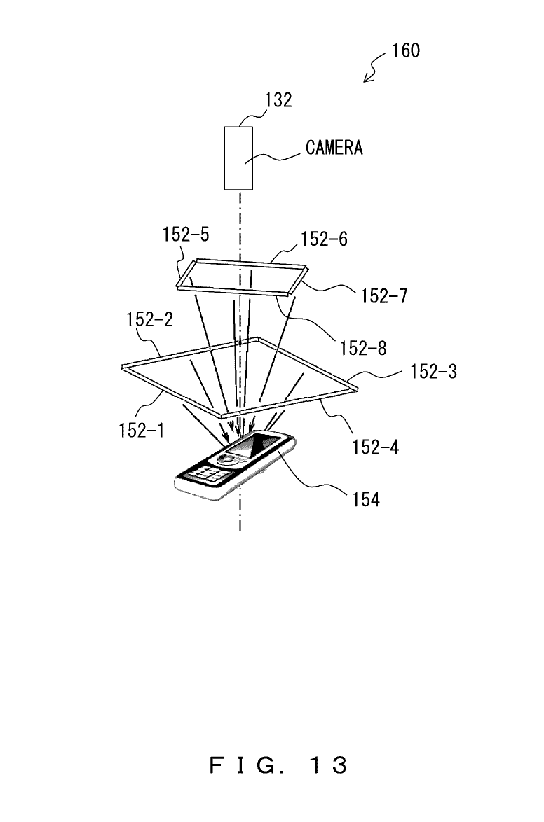

FIG. 13 is a figure presenting an example of an imaging situation 160 by the image processing system 100 according to the second embodiment. The imaging situation 160 is a variation example of the arrangement of illuminations of the image processing system 100. As presented in FIG. 13, in the imaging situation 160, the camera 132 is fixed with respect to an imaging target 154. In addition, a plurality of illuminations 152-1 through 152-8 (also referred to collectively as illuminations 152) are provided. The illuminations 152-1 through 152-4 are provided at positions that are further away from the inspection target 150 than the illuminations 152-5 through 152-8.

In this example, by the illuminations 152-1 through 152-8, the illumination may be cast from at least eight different directions with respect to the inspection target 150. It is preferable that the illuminations 152 be further configured so that the intensity of the illumination light may be changed independently for each. The illuminations 152 may be bar-shaped illuminations, for example, and it is also possible to use images captured by the camera 132 using some of the plurality of these illuminations 152-1 through 152-8 and sequentially turning on these illuminations, for example.

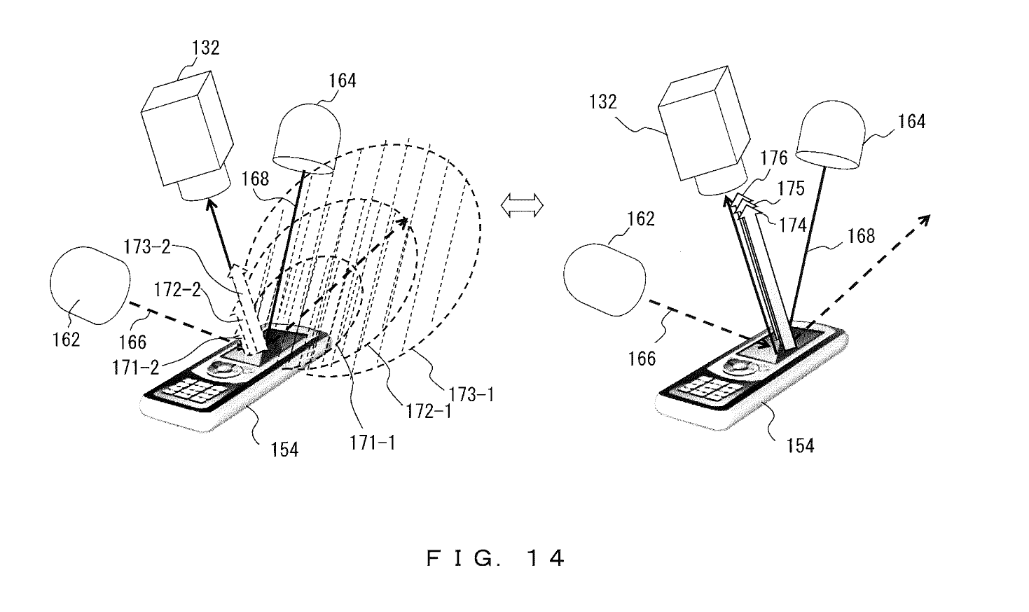

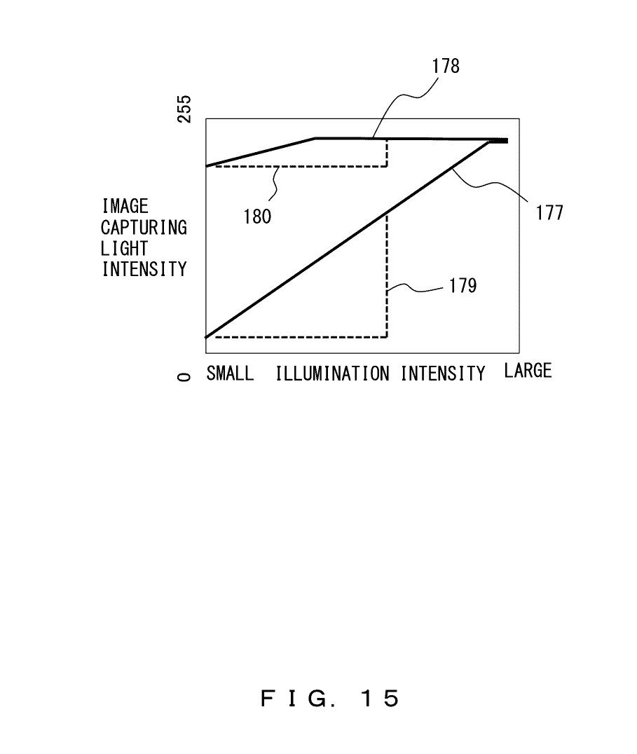

Hereinafter, with reference to FIG. 14 and FIG. 15, the method for removing an image that includes directly reflected light (referred to as a directly reflected light image below) is explained. FIG. 14 is a figure presenting an example of an occurrence of directly reflected light. FIG. 14 is an example in which an image of the imaging target 154 is captured by the camera 132, and it presents a case in which lights of different intensities are cast respectively from an illumination 162 and an illumination 164. In this example, the illumination 164 and the camera 132 are placed at positions of the regular reflection condition. Directly reflected light represents illumination light that is reflected on the imaging target under the regular reflection condition and directly enters the camera. The light that is reflected by the imaging target in cases other than the regular reflection condition and enters the camera is called diffuse reflection light.

It is assumed that for both the illumination 162 and the illumination 164, a sufficiently large illumination intensity may be set. At this time, when the illumination intensity for each is set as a value that exceeds the dynamic range of the camera, highlighting is generated in the captured image no matter which of the illuminations is used. However, in the case of the illumination 164 in the regular reflection condition, even when the illumination intensity is reduced, there is still a possibility that the illumination light source itself will be reflected in the captured image. On the other hand, in the case of the illumination 162 that is not in the regular reflection condition, by appropriately reducing the illumination intensity, the influence of highlighting may be reduced to a degree that does not affect the collection of the surface information, and in which there is no reflection of the illumination light source.

That is, in the example in FIG. 14, the directly reflected light due to the illumination light in an illumination direction 166 from the illumination 162 is reflected in a direction that is different from that of the camera 132, as indicated with intensities 171-1 through 173-1. At this time, the light that enters the camera 132 has intensities 171-2 through 173-2 which change according to intensities 171-1 through 173-1.

On the other hand, the directly reflected light due to the illumination light in an illumination direction 168 from the illumination 164 is reflected in the direction of the camera 132. At this time, in some cases, even when the intensity due to the illumination 164 is changed, intensities 174 through 176 may not change according to the change in the intensity of the illumination light.

FIG. 15 is a figure presenting an example of the change in imaging light intensity. In FIG. 15, the horizontal axis represents the intensity of the illumination light (for example, the intensity of the illumination light set in the illumination apparatus), and the vertical axis represents the intensity of the imaging light (the intensity of the light received by the camera 132). Meanwhile, an intensity curve 177 corresponds to the illumination 162, and an intensity curve 178 corresponds to the illumination 164. In addition, it is assumed that the illumination 162 and the illumination 164 are illuminations of the same specifications.

As presented in FIG. 15, the intensity curve 177 does not include directly reflected light, and therefore, the intensity of the imaging light increases in proportion to the intensity of the illumination 162. However, the intensity curve 178 mainly receives directly reflected light, and therefore, the reflected light component is guided to the camera with a good efficiency, and above a certain intensity, the intensity of the imaging light saturates and does not change even when the intensity of the illumination 164 is increased. Therefore, a change ratio 180 of the imaging light with respect to the change in the illumination light intensity in the case of directly reflected light is considered as smaller than a change ratio 179 in the case other than directly reflected light. For the difference in the change ratios, comparison may also be made with the change ratio including the saturated portion of the intensity curve 178, for example. Using this difference in the change ratios, the selecting unit 107 is able to exclude images that include highlighting due to directly reflected light. At this time, in place of the removed image, the direction of the illumination may be readjusted and an image may be recaptured.

In the present embodiment, when the change for the sum of the luminance values of all the pixels in a divided image is equal to or smaller than a third prescribed value determined in advance with respect to the change in the intensity of the illumination 162 or the illumination 164, the selecting unit 107 removes the divided image from the selection target. That is, the selecting unit 107 removes the divided image from the selection target by raising a flag that is different from the selection flag 29 for the divided image in the selected image table 27, for example. The third prescribed value may be determined according to the difference between the change ratio 179 and the change ratio 180, for example.

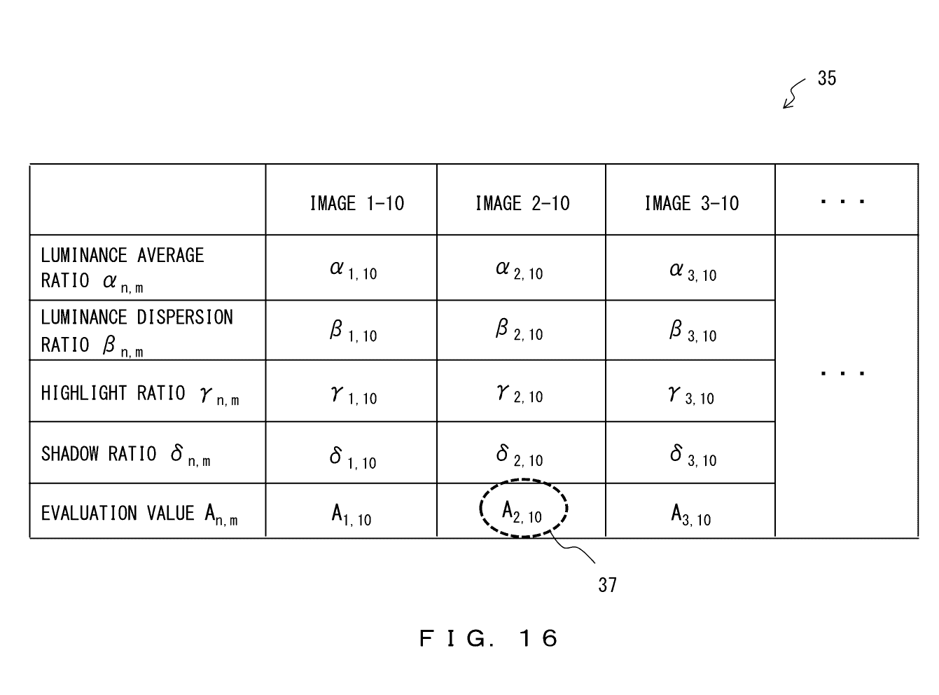

Hereinafter, with reference to FIG. 16 through FIG. 19, an evaluation value of the divided image according to the second embodiment is explained. FIG. 16 is a figure presenting an example of an evaluation value table 35 according to the second embodiment. The evaluation value table 35 is information that represents a statistical amount of a feature amount of the divided image, and the calculation result of the evaluation value. The evaluation value table 35 is generated by the selecting unit 107 for each divided image, for example. It is preferable that the evaluation value be calculated for the divided image that did not become the target of removal by the removal of directly reflected light mentioned above.

The feature amount is a value that represents a feature of the divided image, and is calculated according to illumination information in the divided image. Here, in a similar manner to the evaluation value table 25 according to the first embodiment, the feature amount is the luminance gradation value of each pixel. In the example in FIG. 16, as the statistical amount that becomes the base for the calculation of the evaluation value, in addition to the luminance average ratio α_{n,m} explained in the first embodiment, a luminance dispersion ratio β_{n,m}, a highlighting ratio γ_{n,m}, and a shadow ratio δ_{n,m} with respect to the divided image n-m are described.

The luminance dispersion ratio β_{n,m} is the luminance dispersion ratio of the divided image n-m, and is calculated by formula 2 below. Here, the luminance dispersion std_{n,m} is the square root of the average value of the square of the difference between each luminance gradation value and the average value in the divided image n-m. The luminance dispersion ratio β_{n,m} is the difference between the luminance dispersion std_{n,m} and the luminance dispersion reference value (for example, luminance gradation range/6=255/6=42.5). Here, the luminance gradation range is divided by “6” because it is assumed that, supposing that the luminance distribution is a normal distribution, the case in which 99.7% of all the samples are included in the range of ±3σ, assuming a standard deviation of σ, is sufficiently good as an image.

$${std}_{n , m} = \sqrt{\frac{{\sum }_{x = 0}^{j - 1} {\sum }_{y = 0}^{k - 1} {( f ( x , y ) - {avr}_{n , m} )}^{2}}{jk}} \\ {β}_{n , m} = \vert {std}_{n , m} - 42.5 \vert \qquad ( formula 2 )$$

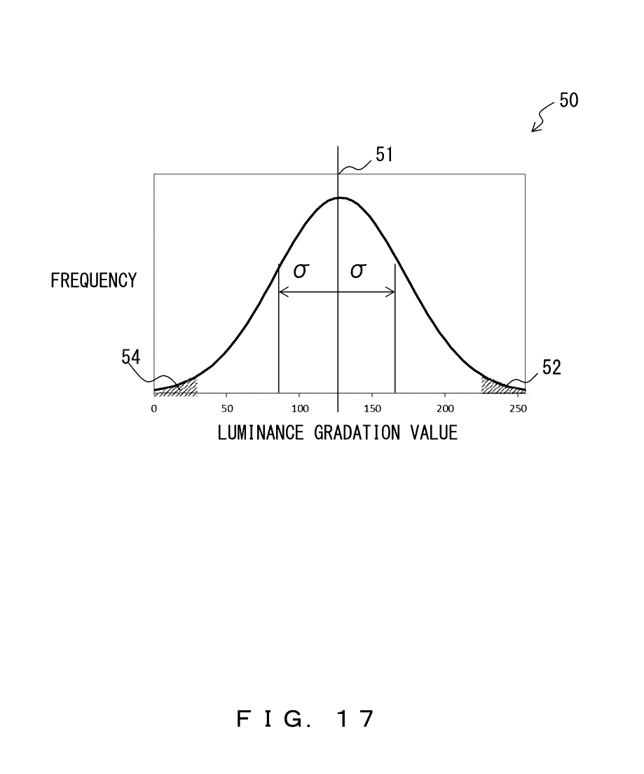

Here, with reference to FIG. 17, the highlighting ratio γ_{n,m} and the shadow ratio δ_{n,m} are explained. FIG. 17 is a figure presenting a luminance distribution 50 in a case in which the frequency of the luminance gradation values is supposed to represent a normal distribution. As presented in FIG. 17, in the luminance distribution 50, the horizontal axis represents the luminance gradation value, and the vertical axis represents the frequency. A straight line 51 is a straight line that represents the gradation value=128, and the luminance distribution 50 is a normal distribution whose center is this straight line 51. In addition, the standard deviation σ is indicated. At this time, a highlighting area 52 is the area in which the luminance gradation value is equal to or higher than a first prescribed value. A shadow area 54 is the area in which the luminance value is equal to or lower than a second prescribed value. The first prescribed value may be determined, using the standard deviation σ, to be a luminance gradation value that is +pσ (p is any real number) from the straight line 51, for example. In a similar manner, the second prescribed value may be determined, using the standard deviation σ, to be a luminance gradation value that is −pσ (p is any real number) from the straight line 51, for example.

Back in FIG. 16, the highlighting ratio γ_{n,m} is the ratio of the number of pixels (hereinafter, referred to as the number of highlighting pixels) included in the highlighting area 52 mentioned above to the total number of pixels in the divided image n-m, and is expressed by formula 3 below.

Highlighting ratioγ_{n,m}=Number of highlighting pixels/Total number of pixels(j×k) (formula 3)

The shadow ratio δ_{n,m} is the ratio of the number of pixels (hereinafter, referred to as the number of shadow pixels) included in the shadow area 54 mentioned above to the total number of pixels in the divided image n-m, and is expressed by formula 4.

Shadow ratioδ_{n,m}=Number of shadow pixels/Total number of pixels(j×k) (formula 4)

In the evaluation value table 35, an example of the results of calculation of the luminance average ratio α_{n,m}, the luminance dispersion ratio β_{n,m}, the highlighting ratio γ_{n,m} and the shadow ratio δ_{n,m} described above for each of the divided images 1-10, 2-10, 3-10 is presented. Meanwhile, the luminance average ratio α_{n,m}, the luminance dispersion ratio β_{n,m}, the highlighting ratio γ_{n,m}, and the shadow ratio δ_{n,m} are statistical amounts calculated according to the luminance gradation values f (x, y) as described above.

The evaluation value A_{n,m} of the divided image n-m is calculated by formula 5 below, for example. Here, factors a through d are a factor multiplied by the respective statistical amounts.

A_{n,m}=aα_{n,m}+bβ_{n,m}cγ_{n,m}+dδ_{n,m} (formula 5)

It is preferable that the factors a through d be determined so that the frequency distribution represented by each feature amount with respect to the corresponding divided image may be normalized. For example, it is preferable that the determination be made so that the frequency distribution of the luminance gradation values becomes close to a Gaussian distribution whose center is the median of the luminance gradation values. For the factors a through d, each reciprocal statistical amount may be a guideline, in the case in which the luminance average ratio α_{n,m}, the luminance dispersion ratio β_{n,m}, the highlighting ratio γ_{n,m}, and the shadow ratio δ_{n,m} are independent from each other. That is, formula 6 below may be used. Here, the average values αₐᵥ, βₐᵥ, γₐᵥ, δₐᵥ are average values of the respective statistical amounts of all the divided images.

a=−(1/αₐᵥ), b=−(1/βₐᵥ), c=−(1/γₐᵥ), d=−(1/δₐᵥ) (formula 6)

The minus sign assigned to the value is simply for the purpose of calculation for selecting the divided image that has the largest value as the evaluation value. For example, in the example in FIG. 16, as indicated with a value 37, the image 2-10 that has the evaluation value A_{2,10} that is the largest value in the calculated evaluation values A_{1,10}, A_{2,10}, A_{3,10} is selected.

Further, at this time, when combining images, instead of selecting one divided image, divided images for combining purposes may be obtained by calculation, by multiplying the divided images with a weighting factor K_{n,m}. For example, assuming the divided images of an area m of an original image n to be divided images I_{n,m} and the number of original images to be N (an integer that is 2 or larger), a divided image Iₘ for the m-th area for the combining purpose is obtained.

$$Im = {\sum }_{n = 1}^{N} {K}_{n , m} \times {i}_{n , m} \qquad ( formula 7 )$$

For example, when there are four divided images for the same area m (N=4), the following is the case. At this time, the evaluation value is expressed as A_{n,m}=(A_{1,m}, A_{2,m}, A_{3,m}, A_{4, m}). Meanwhile, the weighting factor is expressed as K_{n,m}=(K_{1, m}, K_{2,m}, K_{3,m}, K_{4,m}). As the weighting factors K_{n,m}, the weighting factor K_{n,m} corresponding to the largest value in the evaluation values A_{n,m} may be “1”, and others may be “0”, and in this case, K_{n,m}=(0, 1, 0, 0), Iₘ=i_{2,m}. That is, this corresponds to the case in which the divided image based on the original image n=2 is selected, as with the value 37 in FIG. 16. Meanwhile, the weighting factor K_{n,m} may be an example other than that described above.

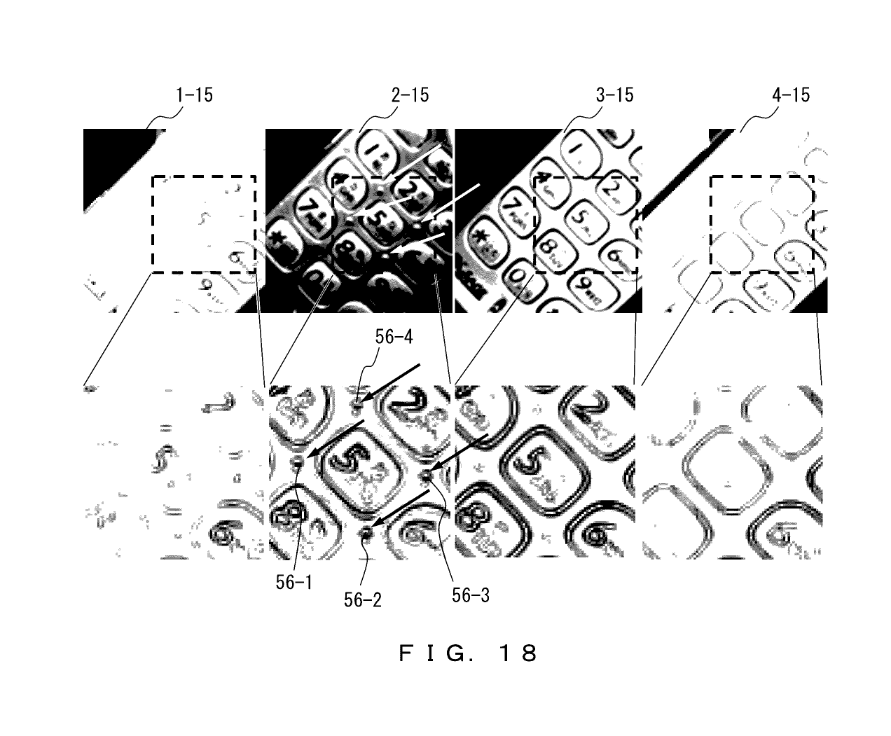

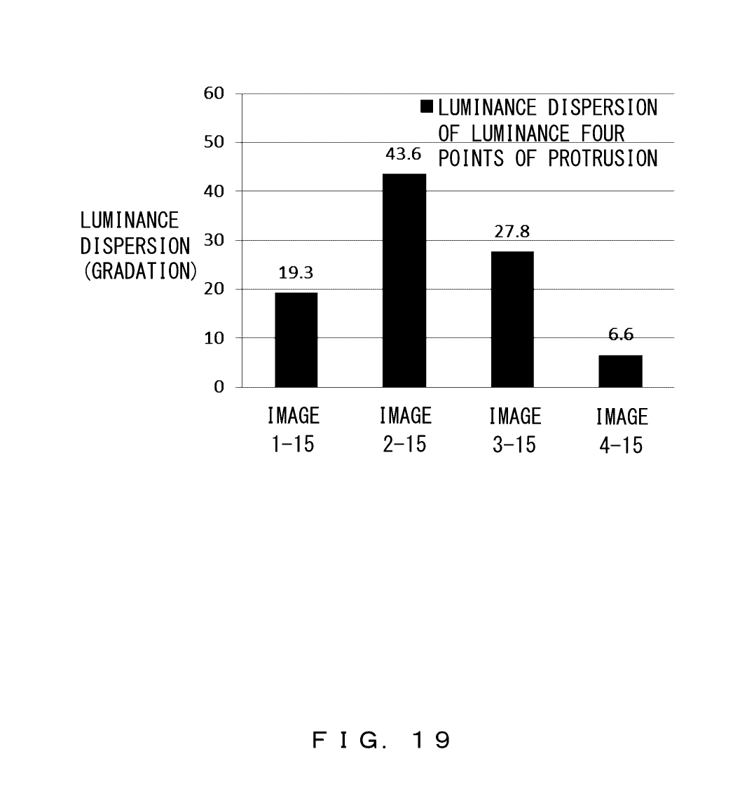

Here, with reference to FIG. 18 and FIG. 19, an example of the effect of selecting divided images is explained. FIG. 18 is a figure presenting images of a portion that includes images 1-15, 2-15, 3-15, 4-15 of the 15th area (collectively referred to as images 1-15 through 4-15 below) and images that include protrusions 56-1 through 56-4 (also collectively referred to as protrusions 56). As presented in FIG. 18, the protrusions 56-1 through 56-4 are identifiable in the image 2-15, but are in a state in which identification is difficult in other images.

FIG. 19 is a diagram presenting the luminance dispersion in the pixels corresponding to the protrusions 56 in the images 1-15 through 4-15. In FIG. 19, the vertical axis represents the luminance dispersion, and the horizontal axis corresponds to the respective images 1-15 through 4-15. The luminance dispersion in FIG. 19 is, for example, the square root of the average of the square of the difference between the luminance gradation value in the pixels corresponding to the respective protrusions 56 and the average value of the luminance gradation values in the divided image n-m.

As presented in FIG. 19, the luminance dispersion has the highest value in divided image 2-15 in which the four protrusions 56 are most distinct in FIG. 18, which is about six times the luminance dispersion of the lowest image 4-15. Thus, it is understood that the distinctness of the image is quantitatively expressed by the luminance dispersion only. Therefore, by adopting the luminance dispersion as the evaluation value, it becomes possible to generate an image that appropriately includes surface information.

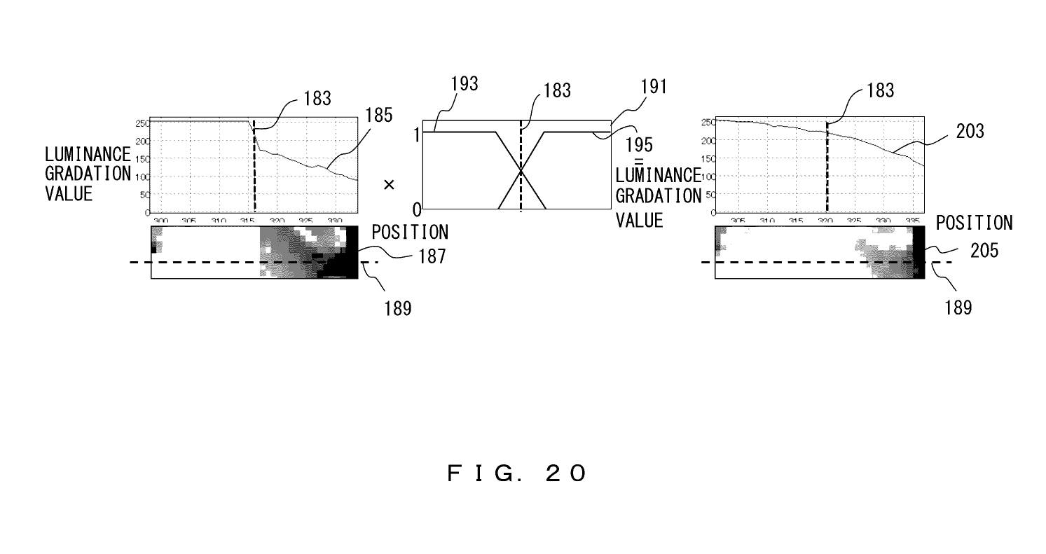

Hereinafter, with reference to FIG. 20, the boundary processing is explained. As presented in FIG. 20, a partial image 187 is an example of a partial image of the boundary portion between divided images. A reference line 189 is a straight line across a boundary line 183. A luminance curve 185 is a curve that represents the change in the luminance value on the reference line 189. When recombining selected divided images, the change in the luminance in adjacent divided images near the boundary may become unnatural, as in the luminance curve 185. In such a case, it is preferable that the combining unit 109 redistribute the luminance values in the boundary area between divided images according to a compounding ratio curve 193 and a compounding ratio curve 195, as shown with a compounding ratio 191. For example, assuming a pixel (x, y) in a divided image and that the compounding ratio curve 193 is expressed as g(x, y) and the compounding ratio curve 195 is expressed as (1−g(x, y)), the luminance gradation value I (x, y) in the pixel (x, y) after redistribution is calculated by formula 8 below, for example.

I(x,y)=g(x,y)×Iₙ(x,y)+(1−g(x,y))×Iₘ₊₁(x,y) (formula 8)

The partial image 205 is an image generated as a result of redistribution performed according to the compounding ratio 191. A luminance curve 203 is a curve that represents the change in the luminance value on the boundary line 183 in the partial image 205. In the partial image 205, the change in the luminance value near the boundary line 183 is smooth, and the boundary between divided images is inconspicuous.

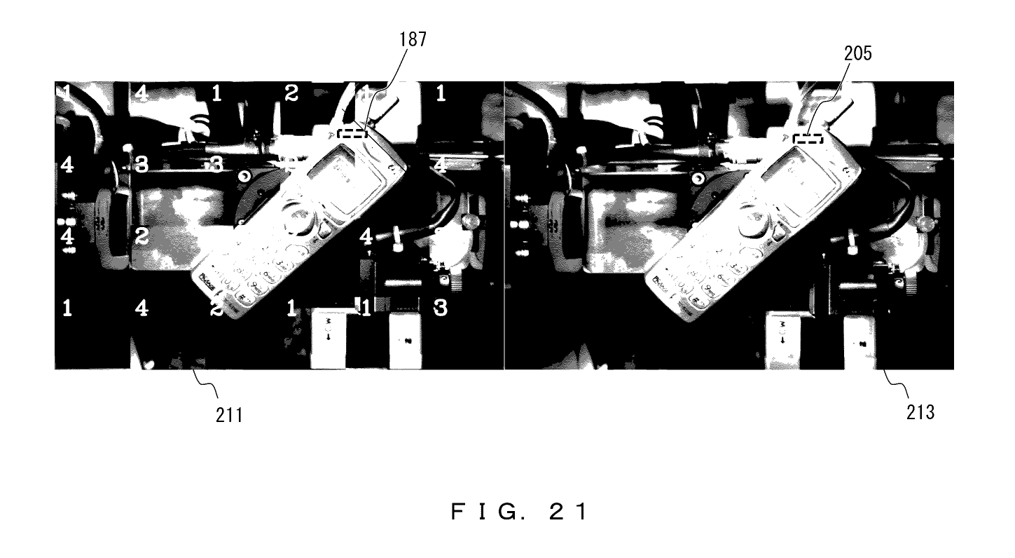

FIG. 21 is a diagram presenting an example of a recombined image before and after the boundary processing described above is performed. As presented in FIG. 21, in a recombined image 211 before the boundary processing is performed, the boundary portion is unnatural, as in a partial image 187 or the like. In a recombined image 213, the unnaturalness in the boundary portion is reduced.

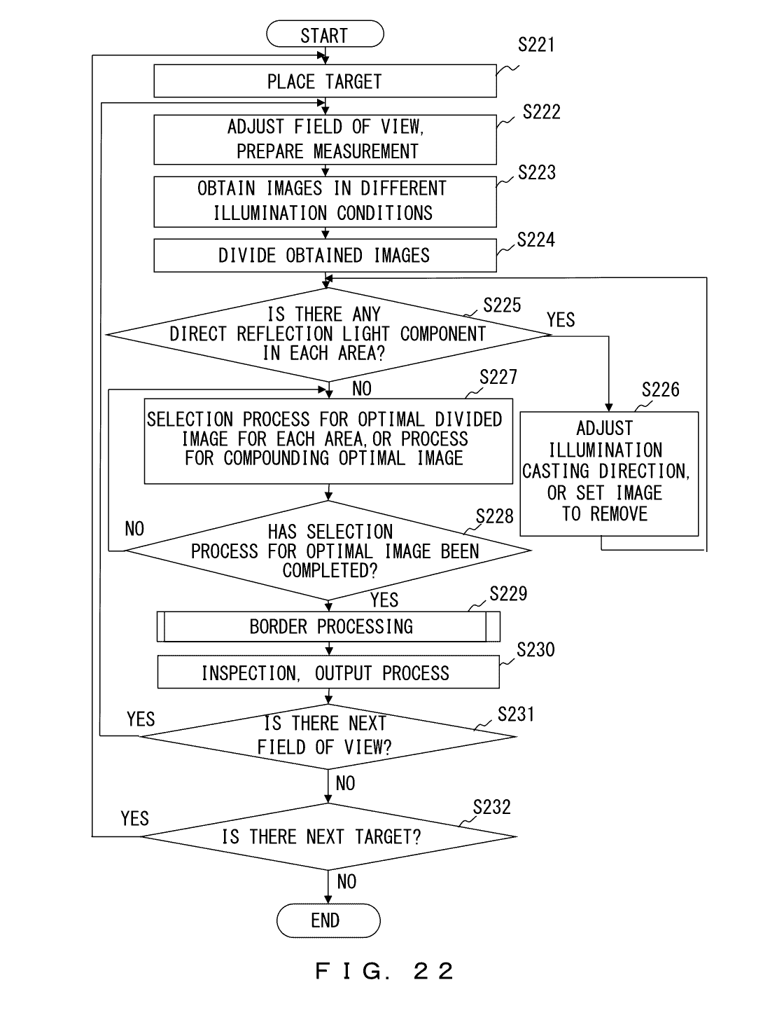

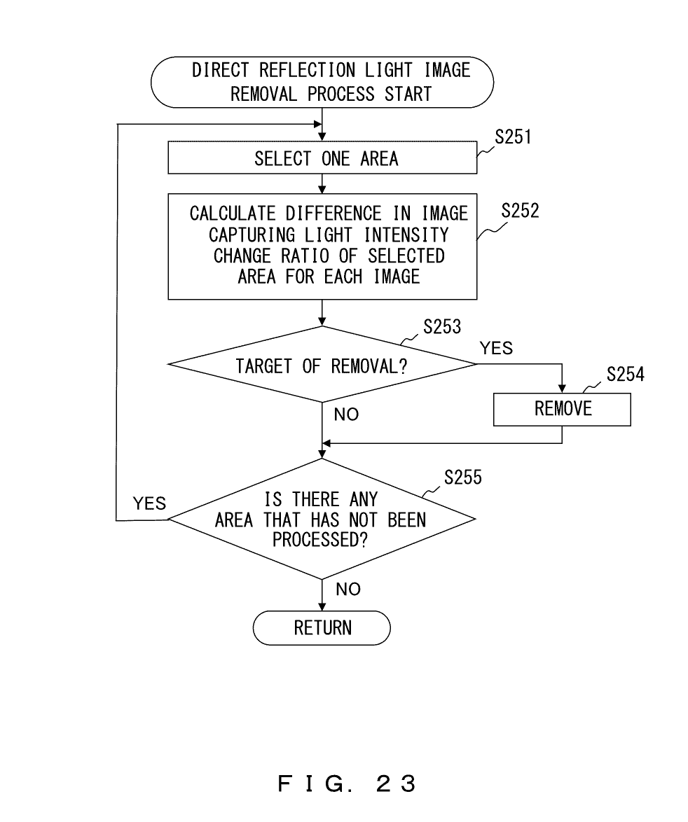

Hereinafter, with reference to flowcharts, operations of the image processing by the image processing system 100 are explained. FIG. 22 is a flowchart presenting major operations of the image processing system 100. In the example in FIG. 22, the image processing system 100 includes a function as a surface inspection apparatus. FIG. 23 through FIG. 25 are flowcharts presenting detailed operations of the processes presented in FIG. 22.

As presented in FIG. 22, in the image processing system 100, for example, the control apparatus 110 places the inspection target 150 on the stage 143 by means of a placing mechanism that is not presented in the drawing (S221). The control apparatus 110 makes preparation for measurement. That is, the illumination control unit 113 adjusts the position, intensity and the like of the illuminations 122 of the illumination apparatus 120 via the illumination controller 124. The imaging control unit 115 adjusts imaging conditions such as the focus, stop, exposure time and the like of the camera 132 of the imaging apparatus 130 via the imaging controller 134. The stage control unit 117 adjusts the position of the stage 143 via the stage controller 145, to make an adjustment so that the inspection target 150 is within the field of view of the camera 132 (S222).

When the completion of the measurement preparation is detected, the imaging control unit 115 makes the imaging apparatus 130 capture a plurality of images under different illumination conditions. Meanwhile, the image accepting unit 103 accepts a plurality of images, to be stored, for example, in the storage device 140 (S223). When the storage of images in the storage apparatus 140 is detected, the image dividing unit 105 divides the plurality of images accepted by the image accepting unit 103 into a plurality of areas (S224).

It is preferable that the selecting unit 107 perform the directly reflected light image removal process for the respective divided images, as described above. When there is any directly reflected light image as a result of the directly reflected light image removal process (S225: YES), the selecting unit 107 performs adjustment of the illuminations 122 by means of the illumination control unit 113, or deletes the image from the target of selection (S226). When adjustment of the illuminations 122 has been performed, the control apparatus 110 captures the original image again by the camera 132, divides the captured image by means of the image dividing unit 105, and repeats the process from S255. At this time, the control apparatus 110 may also remove the original image of the divided images from the target of processing. Details of the directly reflected light image removal process are described later.

When there is no directly reflected light image (S225: NO), for example, as described above, the evaluation value is calculated for each area, and a divided image is selected according to the evaluation value (S227). In some cases, the divided images for each area for recombining purposes are generated by performing calculation in which a plurality of divided images are multiplied by the weighting factors K_{n,m}. When the selection of divided images has not been completed for all the areas, (S228: NO), the selecting unit 107 returns to S227 and repeats the process. When the selection of divided images has been completed for all the areas (S228: YES), the combining unit 109 performs the process for redistributing the luminance values in the boundary portion between divided images, and recombines the images (S229). The output control unit 119 performs prescribed inspection or the like for the recombined image, and outputs the result (S230). The prescribed inspection is surface inspection of the inspection target 150 or the like, for example.

When there is a next field of view (S231: YES), the control apparatus 110 repeats the processing from S222, and when there is none (S231: NO), it brings the process forward to S232. When there is a next imaging target (S232: YES), the control apparatus 110 repeats the processing from S221, and when there is none, it terminates the series of image processing (S232: NO).

Next, with reference to FIG. 23, the directly reflected light image removal process is further explained. The directly reflected light image removal process is the process of S225 and S226 in FIG. 23. The selecting unit 107 selects one area from a plurality of areas (S251). The selecting unit 107 calculates the imaging light intensity change ratio of the selected area for each divided image, as explained with reference to FIG. 15, for example (S252).

When the imaging light intensity change ratio is smaller than a third prescribed value that is set in advance, the selecting unit 107 determines that the corresponding divided image is the target of removal (S253: YES), and performs a process for making the selected image table 27 memorize that the corresponding divided image is a target of removal, for example (S254). When the imaging light intensity change ratio is equal to or larger than the value that is set in advance, it is determined that that the corresponding divided image is not the target of removal (S253: NO).

When there is any area that has not been processed (S255: YES), the selecting unit 107 repeats the process from S251. When there are no areas that have not been processed (S255: NO), the selecting unit 107 brings the process back to S225 in FIG. 23.

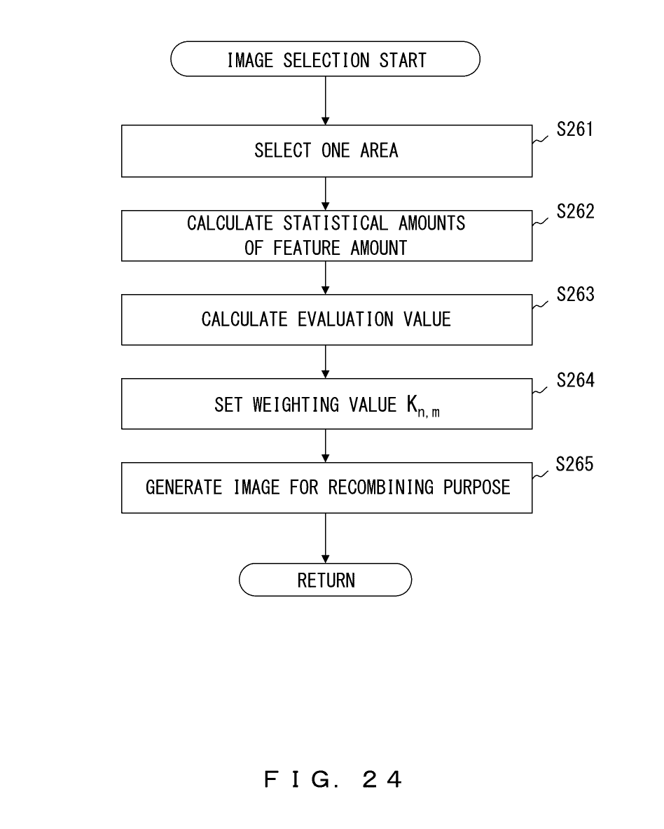

Next, with reference to FIG. 24, the image selection process is further explained. The image selection process is the process of S227 in FIG. 22. The selecting unit 107 selects one area from a plurality of areas (S261). As explained with reference to FIG. 16 and FIG. 17, first, the selecting unit 107 calculates the luminance dispersion ratio β_{n,m}, the highlighting ratio γ_{n,m}, and the shadow ratio δ_{n,m} in addition to the luminance average ratio α_{n,m}, as the statistical amounts for which the feature amount is the luminance gradation value (S262). The selecting unit 107 calculates the evaluation value by formula 5, according to the calculated statistical amounts (step 263). Further, the selecting unit 107 sets the weighting factor K_{n,m} (S264). The selecting unit 107 generates a divided image for recombining purposes according to formula 6 (S265), and brings the process back to S227 in FIG. 22.

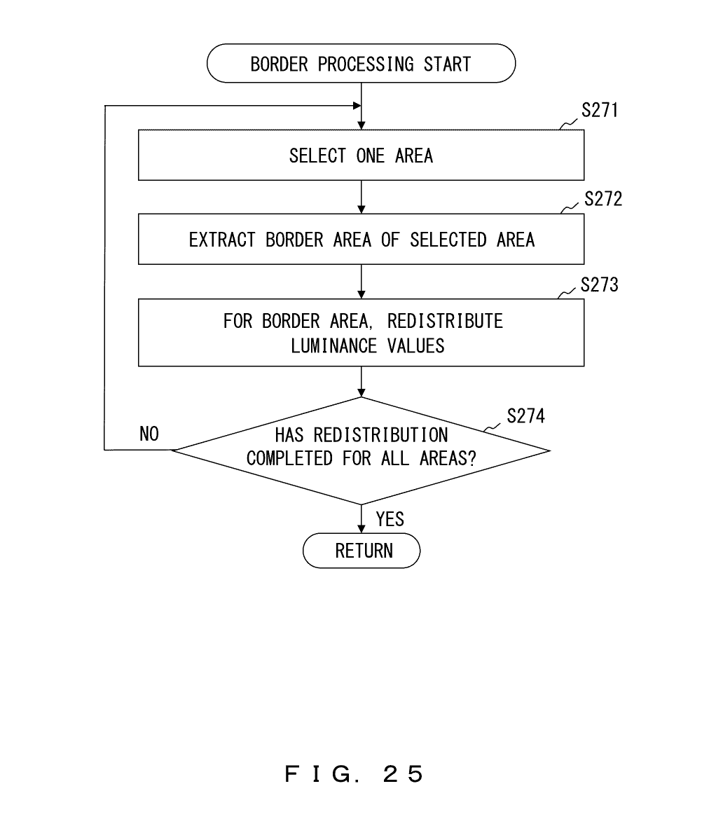

Next, with reference to FIG. 25, the boundary processing is explained. The boundary processing is the process of S229 in FIG. 22. As explained with reference to FIG. 20 and FIG. 21, it is preferable that the combining unit 109 perform redistribution of luminance values for the boundary portion between divided images. The combining unit 109 selects one area from a plurality of areas (S271). The combining unit 109 extracts an area that is adjacent to the selected area (S272). For example, the m-th area and the m+1-th area.

The combining unit 109 obtains the luminance value after redistribution by formula 8, for example (S273). When redistribution has not been completed for all the areas (S274: NO), the combining unit 109 returns to S271 and repeats the processing, and upon completion (S274: YES), brings the process back to S229 in FIG. 22.

As described in detail above, according to the image processing system 100, a plurality of images are captured under a plurality of illumination conditions with the same field of view that includes an imaging target. The control apparatus 110 makes the storage apparatus 140 store the captured images. The image accepting unit 103 reads and accepts images from the storage apparatus 140. The image dividing unit 105 divides the accepted image into a divided image of a plurality of areas.

The selecting unit 107 performs a directly reflected light removing process. In addition, the selecting unit 107 selects a divided image for each area by calculating a statistical amount based on the luminance gradation value for example, and by further calculating an evaluation value based on the calculated statistical amount. At this time, the weighting factor K_{n,m} may be introduced, and the divided image for purposes of recombining may be generated by multiplying a plurality of divided images for each area with the weighting.

The combining unit 109 combines the selected or generated divided images for purposes of recombining and generates a recombined image. At this, by boundary processing, the luminance value of each pixel near the adjacent boundary areas may be multiplied by a factor 0-1 and the adjacent areas may be added to each other, so as to redistribute luminance values in the boundary portion between areas.

As described above, by the image processing system according to the second embodiment, images of an imaging target may be captured under a plurality of illumination conditions with the same field of view. In addition, a value in which a plurality of statistical amounts are multiplied by a factor and added may be the evaluation value. Accordingly, divided images with little influence from factors such as highlighting or the like that makes the image unclear may further be selected appropriately and may be combined, and an image that includes surface information of the imaging target in a sufficiently identifiable manner may be obtained.

By performing directly reflected light image removal, highlighting due to directly reflected light and highlighting due to an increase in the intensity of reflected light due to diffuse reflection light may be distinguished, and an image in which highlighting is more appropriately reduced may be obtained.

By performing boundary processing, the boundary may be connected smoothly, and furthermore, the influence of highlighting may be reduced, and a recombined image that includes surface information of the inspection target 150 more appropriately may be obtained. At this time, averaging of adjacent images is performed, and therefore, there is also an effect of noise reduction.

With the image processing system 100, for example, usage as an inspection apparatus is also possible, for performing inspection as to whether a prescribed image and a recombined image include the same inspection target 150, for example. As the inspection method, conventional methods such as execution of matching between pixels may be used. As such an inspection apparatus, by performing the image processing described above, highlighting that causes negative influences on the inspection may be reduced, and inspection accuracy may be improved.

In particular, an image may be obtained that appropriately includes, across a transparent member, image information of an imaging target that has a surface portion covered by the transparent member, or the surface shape of a target that has a smooth surface shape. Therefore, an image may be obtained with which it is possible to perform surface inspection with a good accuracy for an imaging target for which accurate inspection has been difficult.

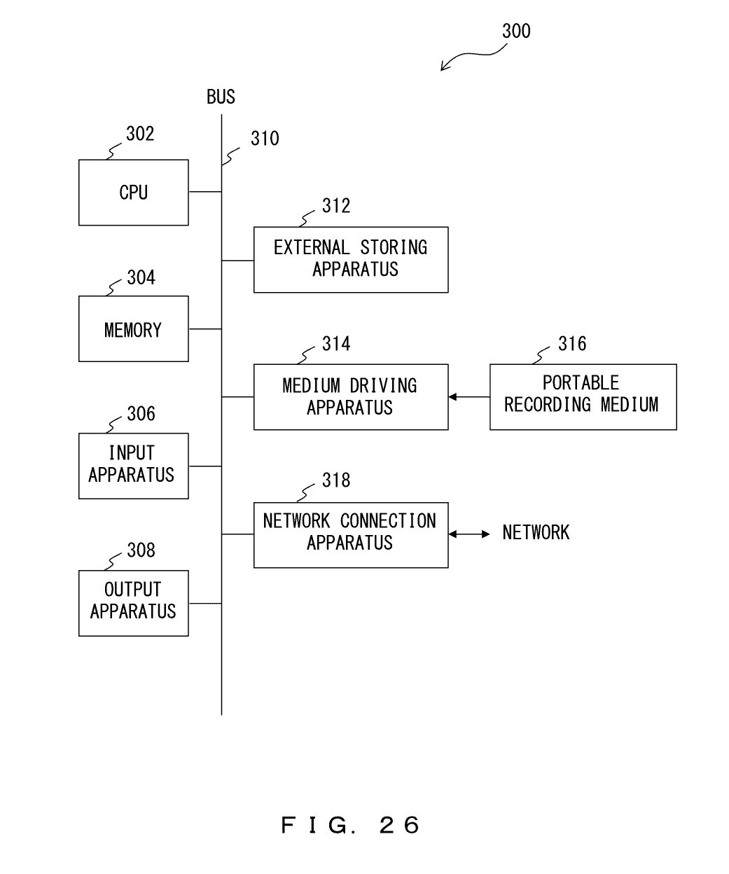

Here, an example of a computer applied in common in order to cause a computer to execute operations of the image processing method according to the first or second embodiment is explained. FIG. 26 is a block diagram presenting an example of the hardware configuration of a standard computer. As presented in FIG. 26, in a computer 300, a Central Processing Unit (CPU) 302, a memory 304, an input apparatus 306, an output apparatus 308, an external storage apparatus 312, a medium driving apparatus 314, a network connection apparatus and the like are connected via a bus 310.

The CPU 302 is a processing apparatus that controls the overall operations of the computer 300. The memory 304 is a storage apparatus for storing in advance a program that controls operations of the computer 300 and is to be used as a work area as needed when executing a program. The memory 304 is a Random Access Memory (RAM), a Read Only Memory (ROM), or the like, for example. The input apparatus 306 is an apparatus that obtains, when operated by the user of the computer, the input of various pieces of information from the user that is associated with the content of the operation, and sends the obtained information to the CPU 302, and it is a keyboard apparatus, a mouse apparatus, or the like, for example. The output apparatus 308 is an apparatus that outputs the processing result by the computer 300, and includes a display apparatus or the like. The display apparatus displays text or an image according to display data sent from the CPU 302.

The external storage apparatus 312 is a storage apparatus such as a hard disk or the like that is an apparatus for storing various control programs executed by the CPU 302 and obtained data and the like. The medium driving apparatus 314 is an apparatus for performing writing and reading with a portable recording medium 316. The CPU 302 may be configured to perform various control processes by reading, via the medium driving apparatus 314, and executing a prescribed control program recorded in the portable recording medium 316. The portable recording medium 316 is a Compact Disc (CD)-ROM, a Digital Versatile Disc (DVD), a Universal Serial Bus (USB) memory, or the like. The network connection apparatus 318 is an interface apparatus that manages the exchange of various pieces of data performed via a wire or wirelessly with the outside. The bus 310 is a communication path for connecting the respective apparatuses mentioned above with each other and for performing data exchange.

The program that causes a computer to execute the image processing method according to the first or second embodiment described above is stored in the external storage apparatus 312, for example. The CPU 302 reads the program from the external storage apparatus 312, and makes the computer execute operations of image processing. At this time, first, a control program for causing the CPU 302 to execute the process of image processing is created and stored in the external storage apparatus 312. Then, a prescribed instruction is given from the input apparatus 306 to the CPU 302 so as to read and execute the control program from the external storage apparatus 312. In addition, this program may also be configured to be stored in the portable recording medium 316.

Meanwhile, the present invention is not limited to the embodiments described above, and may take various configurations of embodiments without departing from the gist of the present invention. For example, in the first and second embodiments, the example of calculating the evaluation value based on the statistical amount that is calculated according to luminance information of all the pixels of the divided image was explained. However, for example, as presented in FIG. 19, evaluation may also be made according to an evaluation value that is calculated with respect to only the pixels that correspond to an image that has a particular feature. In addition, one of the respective statistical amounts explained in the second embodiment may be used as the evaluation value in the first embodiment. The calculation method for the statistical amounts of the luminance gradation value is not limited to the above-mentioned method. For example, it is also possible to apply another statistical amount that represents the difference between frequency distribution of luminance information of the divided image and normal distribution, for example. In addition, in the image processing system 100, the image processing apparatus 10 may be used instead of the image processing apparatus 101.

In the directly reflected light image removal process, the boundary processing according to the second embodiment may be omitted. In addition, the calculation method for the factors a through d is not limited to the above-mentioned method. The weighting factor K_{n,m} is not limited to the above-mentioned method, and a combination of other values may be used. In addition, the first embodiment may also be configured so that at least one of the directly reflected light image removal process, the boundary processing, the process using the weighting factor K_{n,m} according to the second embodiment is performed.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing method comprising:
dividing, by a processor, each of a plurality of images in which an imaging target is captured under a plurality of different illumination conditions into a plurality of areas, to generate a plurality of divided images;
selecting, by the processor, according to luminance information of a plurality of divided images corresponding to one area among the plurality of areas, one divided image among the plurality of divided images corresponding to the one area; and
combining, by the processor, the one divided image with divided images corresponding to areas other than the one area, to generate an image corresponding to the plurality of areas.

2. The image processing method according to claim 1, wherein
in the selecting, the one divided image is selected according to a statistical amount of a feature amount with respect to luminance information of pixels included in the plurality of divided images corresponding to the one area.

3. The image processing method according to claim 2, wherein
the feature amount includes at least one of a luminance value, brightness, saturation, or edge intensity.

4. The image processing method according to claim 3, wherein
the statistical amount is at least one of a difference between an average value of luminance values of all pixels of the divided image and a median of values that the luminance values may take, a dispersion ratio of a luminance value of each pixel with respect to the average value of luminance values of all pixels of the divided image, a ratio of a number of pixels whose luminance value is equal to or larger than a first prescribed value to a total number of pixels of the divided image, or a ratio of a number of pixels whose luminance value is equal to or smaller than a second prescribed value to a total number of pixels of the divided image.

5. The image processing method according to claim 1, wherein
the illumination conditions include an illumination direction of an illumination light from an illumination apparatus with respect to the imaging target.

6. The image processing method according to claim 1, wherein
the illumination conditions include illuminance of the imaging target or an exposure state of the imaging apparatus.

7. The image processing method according to claim 6, wherein
the plurality of images include images captured with at least two kinds of the illuminances that are different from each other that have taken a same illumination direction with respect to the imaging target; and
in the selecting, the divided image for which a difference of luminance information of the divided image with respect to a difference in the illuminances that are different from each other is equal to or larger than a third prescribed value is selected.

8. An image processing system comprising:
an illumination apparatus configured to perform illumination for an imaging target under a plurality of illumination conditions;
an imaging apparatus configured to capture an image of the imaging target;
a storage apparatus configured to store information;
an illumination control unit configured to control an operation of the illumination apparatus;
an imaging control unit configured to make an image of the imaging target captured a plurality of times by the imaging apparatus under the illumination conditions that are different from each other, and to store a plurality of captured images in the storage apparatus;
an image dividing unit configured to divide each of the plurality of images stored in the storing unit into a plurality of areas, to generate a plurality of divided images, and also to store the divided images in the storage apparatus;
a selecting unit configured to select, according to luminance information of the plurality of divided images corresponding to one area among the plurality of areas, one divided image among the plurality of divided images corresponding to the one area; and
a combining unit configured to combine the one divided image with divided images of areas other than the one area, to generate an image corresponding to the plurality of areas.

9. The image processing system according to claim 8, wherein
the selecting unit selects the one divided image according to a statistical amount of a feature amount related to luminance information of pixels included in the plurality of divided images corresponding to the one area.

10. The image processing system according to claim 9, wherein the feature amount includes at least one of a luminance value, brightness, saturation, or edge intensity.

11. The image processing system according to claim 10, wherein
the statistical amount is at least one of a difference between an average value of luminance values of all pixels of the divided image and a median of values that the luminance values may take, a dispersion ratio of a luminance value of each pixel with respect to the average value of luminance values of all pixels of the divided image, a ratio of a number of pixels whose luminance value is equal to or larger than a first prescribed value to a total number of pixels of the divided image, or a ratio of a number of pixels whose luminance value is equal to or smaller than a second prescribed value to a total number of pixels of the divided image.

12. The image processing system according to claim 8, wherein
the illumination apparatus is configured to be capable of casting illumination in at least two directions of illumination directions with respect to the imaging target; and
the illumination conditions, the illumination conditions include an illumination direction of an illumination light from the illumination apparatus with respect to the imaging target.

13. The image processing system according to claim 8, wherein
the illumination apparatus is configured to be capable of casting illumination so that the imaging target has at least two kinds of illuminances; and
the illumination conditions include the illuminance of the imaging target.

14. The image processing system according to claim 13, wherein
the illumination control unit controls the illumination apparatus so that the illumination direction is identical and the illuminance changes;
the imaging control unit makes an image of the imaging target captured with at least two kinds of the illuminances that are different from each other that have taken the same illumination direction; and
the selecting unit performs selection from divided images for which a difference of the luminance information of the divided image with respect to a difference in the illuminances that are different from each other is equal to or larger than a third prescribed value.

15. A non-transitory computer-readable recording medium having stored therein a program for causing a computer to execute a process comprising:
dividing each of a plurality of images in which an imaging target is captured under a plurality of different illumination conditions into a plurality of areas, to generate a plurality of divided images;
according to luminance information of a plurality of divided images corresponding to one area among the plurality of areas, selecting one divided image among the plurality of divided images corresponding to the one area; and
combining the one divided image with divided images corresponding to areas other than the one area, to generate an image corresponding to the plurality of areas.
